(19) United States
(12) Patent Application Publication
(10) Pub. No.: US 2022/0187848 A1
(43) Pub. Date: Jun. 16, 2022

(54) ENVIRONMENTAL MONITORING NAVIGATION SYSTEMS AND METHODS FOR SAME

(71) Applicant: Raven Industries, Inc., Sioux Falls, SD (US)

(72) Inventors: Ron Morfitt, Sioux Falls, SD (US); Michael Scott Smith, Sulphur Springs, TX (US); Mark Stanley Ketcham, Sioux Falls, SD (US)

(21) Appl. No.: 17/552,229

(22) Filed: Dec. 15, 2021

Related U.S. Application Data
(60) Provisional application No. 63/125,903, filed on Dec. 15, 2020.

(51) Int. Cl. G05D 1/06; G05D 1/10; B64B 1/62

(52) U.S. Cl. CPC G05D 1/0607; B64B 1/62; G05D 1/101

(57) ABSTRACT

A control system for an atmospheric balloon system includes a navigation parameter system having a meteorological characteristic input, a balloon kinematic monitor, an objective input and a parameter range generator configured to generate an altitude search range for the atmospheric balloon system based on air stream vectors, balloon kinematics, and a target balloon position. An onboard balloon control system is in communication with the navigation parameter system and includes a comparator to determine a course difference of a measured course relative to a course range. An altitude selection module selects a target altitude within the altitude search range having an air stream vector that decreases the course difference. A propulsion selection module is configured to select a propulsion value that decreases the course difference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. of Sioux Falls, S.Dak., USA. All Rights Reserved.

### TECHNICAL FIELD

This document pertains generally, but not by way of limitation, to buoyant devices, such as balloons and airships, and navigation of such devices.

### BACKGROUND

Atmospheric balloon systems provide elevation (altitude) control with one or more buoyancy systems including ballonets, ballast systems (e.g., substractive ballast, such as glass shot), propulsion systems or the like to change and maintain altitude. In some examples atmospheric balloon systems change altitude to move into favorable winds (air streams) that direct the system toward target locations or maintain the systems in target locations in the manner of station seeking.

In other examples, atmospheric balloon systems include propulsion systems, such as propellers, ducted fans or the like to permit changes in course and speed. For instance, the propulsion systems facilitate turning of atmospheric balloon systems and movement of the atmospheric balloon system along a specific course over the ground.

### SUMMARY

The present inventors have recognized, among other things, that a problem to be solved includes assessing air streams (e.g., directional fluid flow) in three dimensions relative to an atmospheric balloon system (e.g., atmospheric balloons, dirigibles, air ships or the like) and positioning the system within three dimensions to Like advantage of the assessed air streams. Previous example systems include elevation control (e.g., with ballonets, ballast, propulsion systems or the like, herein elevation control systems) to move the system vertically into air streams having a desired vector. The system is raised or lowered to the desired air stream with a buoyancy system and then passively moved by and with the air stream. However, the fluid environment around a system is a three dimensional environment and includes variations in fluid flow (e.g., air stream vectors) in a plurality of dimensions, including vertical (along a Z axis), as well as lateral dimensions (along X and Y axes). In various examples fluid flow and corresponding air streams vary in each of these dimensions, and an atmospheric balloon system configured for elevation changes has limited capability of accessing air streams laterally positioned away from the system. In some examples, laterally positioned air streams are inaccessible to the elevation controlled atmospheric balloon systems. Instead, systems having elevation control systems move to air streams that are vertically accessible but less than ideal in comparison to laterally positioned air streams. Accordingly, atmospheric balloon systems that are configured to change elevations are constrained to less than ideal airstreams in comparison to otherwise preferable laterally positioned air streams.

In one example, these buoyant systems arrive more slowly at a specified location, such as a navigation waypoint, because a faster air stream is not available vertically to the system (e.g., faster air streams are positioned laterally instead of vertically). In another example, the buoyant systems pass through a specified location more rapidly than specified because slower air streams are unavailable vertically (e.g., the slower air streams are positioned laterally). In still another example, the buoyant systems are unable to station seek (or station keep), also referred to as dwelling in an area or zone, or navigate to a specified navigation waypoint because an air stream (or streams) that would facilitate these mission goals is not vertically available. In other examples, the buoyant systems are unable to reach a specified location because the vertically available air streams direct the system through a prohibited air space (e.g., of an objecting zone, municipality, state, country or the like).

In other examples, control systems for atmospheric balloon systems use propulsion systems to move laterally (and optionally vertically). For example the control systems monitor a position of the balloon, and a remote controller (e.g., technician or control system) that monitors local air stream vectors remotely provides specified altitude, course and speed settings in an ongoing manner to the atmospheric balloon system to direct the system into a selected air stream vector directed toward a specified latitude and longitude (e.g., a specified target, such as a waypoint). The provided settings, such as specified altitude (A feet), specified course (B degrees relative to North) and specified speed (C, miles per hour) are implemented with the propulsion system and buoyancy system and the atmospheric balloon system moves in the selected air stream vector and is carried toward the specified latitude and longitude (e.g., specified target, such as a waypoint) with air stream assistance. The remote controller conducts ongoing monitoring of the atmospheric balloon system (e.g., its current location) and the remote controller recalculates and updates the specified altitude, course and speed settings to move the atmospheric balloon system to selected air streams as the air streams are observed in proximity to the balloon system. The remote controller operates the atmospheric balloon system remotely with instructions that initiate corresponding operation of the propulsion system or the buoyancy system to achieve the specified settings. The system initiates the operations to move the atmospheric balloon system into favorable local air streams directed toward the specified longitude and latitude (the specified target, such as a waypoint). This method requires ongoing monitoring of the atmospheric balloon system (its current location), calculation of the range and bearing to the specified longitude and latitude (specified target) from the current location of the balloon system, and implementation of updated guidance to select and move into a corresponding air stream vector. This continuous monitoring, calculation and implementation places extra computational requirements on the limited resources on board the balloon system. Additionally, the continuous operation on board the balloon system and relaying of information for subsequent control instructions from the remote controller limits bandwidth for communication of weather conditions (e.g., windspeeds, directions or the like) used to generate wind models to facilitate control of the balloon system.

The present subject matter can help provide a solution to this problem with a control system for an atmospheric balloon system having a navigation parameter system that provides a set of navigation parameters including parameters ranges to a control system onboard an atmospheric balloon system. The control system determines a target altitude within a (navigation parameter system) provided altitude search range that decreases one or more of a course difference or speed difference relative to course and speed ranges (determined with the navigation parameter system) and the balloon kinematics (e.g., present course and speed). For instance, the target altitude includes one or more air streams to decrease one or both of the course difference or speed difference. In another example, the onboard control system provides propulsion instructions to onboard propulsion systems that also decrease the course difference or speed difference relative to the course and speed ranges (e.g., to move the system into an airstream as well as providing additional propulsion or course correction while in the airstream). The atmospheric balloon system including the onboard control system associated with the navigation parameter system is thereby configured to conduct altitude changes to altitudes within an altitude search range having advantageous air streams and then optionally conduct one or more propulsion maneuvers to further decrease differences between the course and speed ranges and the balloon kinematics. Optionally, the propulsion provided to decrease differences moves the atmospheric balloon into advantageous airstreams proximate to the target altitude. In another example, decreasing differences relative to the course and speed ranges includes one or more of changing the course or speed of the balloon system at least to the edges of the course or speed ranges, or into one or more interior component values of the ranges (mean, median, quartiles or the like) or subranges of the course or speed ranges.

By directing the atmospheric balloon to target altitudes, and decreasing course and speed differences relative to the associated ranges the balloon system minimizes ongoing updates of balloon position, speed, course and the like with a remote controller (e.g., ground based) and repeated calculation of altitude changes, course changes and speed changes directed to a specified target location and based on the updated position, speed or course as is the case in other control systems. Instead, the example control systems described herein generates parameter ranges based on one or more of airstream vectors as functions of time, location or the like, current balloon kinematics such as position, course and speed and delivers the parameter ranges to the onboard balloon control system with the atmospheric balloon. The onboard balloon control system of the atmospheric balloon then selects a target altitude within the provided altitude search range that minimizes course and speed differences relative to the respective ranges (of course and speed) by placing the balloon proximate to advantageous airstream vectors to decrease the course and speed differences. The onboard balloon control system optionally includes a propulsion selection module that selects one or more propulsion values for implementation that also decrease one or both of the course difference or speed difference relative to the course and speed ranges (determined with the navigation parameter system).

The control system provides a series of parameter ranges to the onboard balloon control system, and the onboard system then controls balloon performance relative to the parameter ranges instead of repeatedly adjusting control instructions based on ongoing balloon monitoring that triggers relaying of updated instructions for altitude, course and speed changes based on updated balloon location, course and speed monitoring. Additionally, by implementing control of the atmospheric balloon relative to parameter ranges (instead of parameter set points) variation in control with the onboard balloon control system is permitted to achieve combinations of altitude, course and speed that achieve specified guidance with airstream vectors without control of the atmospheric balloon ‘fighting’ to satisfy difficult (power intensive) parameter set points of specified altitude, course and speed.

Further, in some examples altitude selection of a target altitude within the altitude search range provided with the navigation parameter system is prioritized relative to propulsion selection including decreasing course or speed differences relative to the ranges with supplemental propulsion. By prioritizing altitude selection, onboard buoyancy control is implemented to change altitude and higher power demanding propulsion systems are implemented as a second priority to further adjust course or speed to minimize power consumption. For instance, propulsion selection (e.g., of either or both of course or speed) and implementation of the selections (with a balloon control interface) are conducted after selection of a target altitude to promote positioning of the atmospheric balloon within altitude available air stream vectors. Control with propulsion to further decrease course or speed differences relative to the course or speed ranges is then conducted to further enhance guidance and control of the atmospheric balloon.

The control system examples described herein facilitate control of a buoyant system, such as an atmospheric balloon, in multiple dimensions including one or more X, Y and Z dimensions. As further described herein, the control system examples further enhance control in a virtual fourth dimension, time, by accessing air streams that facilitate arrival at navigation waypoints or departure therefrom at one or more times based on the air stream selected and the corresponding position of the atmospheric balloon therein. For example, the control system includes predictive models of airstream vectors (e.g., at future times) based on weather information to plan control of the balloon system to target balloon locations, intervening waypoints or the like that may be ‘off course’ with present air stream vectors. However, given predictive models of airstream vectors the balloon system is guided toward a location having future airstream vectors that enhance arrival of the balloon system at a target location (or waypoint) with decreased power consumption, a specified time of arrival or the like. For instance, as shown in FIG. 7B herein airstream vectors at the present (e.g., t1) are used to position the balloon system initially away from a target balloon position. The predictive models of airstream vectors, for instance at t2, t3 or the like, prompt the control at t1. As shown, the balloon system is guided back to the target balloon position at t2 by a future countervailing airstream vector. In a similar manner, the control system implementation shown in FIG. 3B optionally uses predictive models of air stream vectors at forthcoming locations (e.g., waypoints B, B′ and target balloon position C) to conduct preceding control of the balloon system including, but not limited to, target altitude, preemptive adjustment of course or speed to decrease future differences between course or speed ranges at a forthcoming location or the like. In one example, based on contemporary airstream vectors at B, B′ and C the system guides the balloon at a particular altitude toward B. However, with predictive models of forthcoming future airstream vectors the system selects a different (initially and potentially less efficient) route including a different altitude, course or the like to B instead of B′ because the future airstream vectors from B to C provide a specified arrival time, minimizes balloon system power consumption or the like.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is schematic view of one example of an atmospheric balloon system including an airship.

FIG. 1B is a schematic view of another example of an atmospheric balloon system.

FIG. 2 is a schematic view of a series of waypoints and a target location each having a plurality of associated airstream vectors.

FIG. 3A is another schematic view of the waypoints and target location of FIG. 2 including parameter set point control of the atmospheric balloon system.

FIG. 3B is another schematic view of the waypoints and target location of FIG. 2 including parameter range control of the atmospheric balloon system.

FIG. 4 is a schematic view of one example of a parameter range control system for at atmospheric balloon system.

FIG. 5 is a schematic view of one example of a method of conducting parameter range control.

FIG. 6 is a detailed schematic view of one example of parameter range control.

FIG. 7A is a schematic view of parameter range control as part of an example station seeking mission.

FIG. 7B is a schematic view of parameter range control as part of another example station seeking mission.

### DETAILED DESCRIPTION

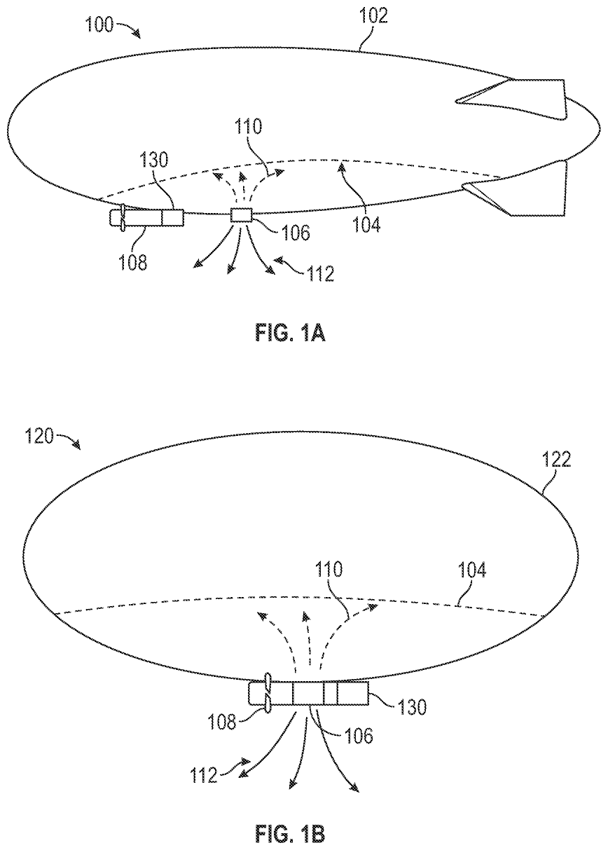

FIGS. 1A and 1B illustrate example atmospheric balloon systems 100, 120. The atmospheric balloon systems 100, 120 include, but are not limited to, airships dirigibles, balloons, aerostats or the like. An example airship is shown in FIG. 1A and an example high altitude balloon is shown in FIG. 1B. Each of the systems 100, 120 includes associated balloons 102, 122 configured to receive and retain a quantity of lift gas, such as helium, hydrogen or the like to provide buoyancy to the systems 100, 120 and their associated payloads.

As further shown in FIGS. 1A and 1B, the systems 100, 120 includes ballast systems 104 to control buoyancy, for instance to maintain to change altitude. The ballast systems 104 are examples of an elevation control system. In other examples, the elevation control system includes the propulsion system 108 configured to actively ascend and descend the balloon systems 100, 120.

As discussed herein, selection of an altitude, guidance to the selected altitude is conducted to move the atmospheric balloon systems 100, 120 into various air streams or the like, for instance monitored from a remote station having a navigation parameter system. In the examples shown in FIGS. 1A and 1B the ballast systems 104 includes a ballonet separated from the remainder of the balloons 102 (or 122 in FIG. 1B) with a membrane shown with a dashed line. One or more ballonet blowers 106 provide a flow of fluid, such as atmosphere into and out of the ballonet to control the buoyancy of the balloons 102, 122 and the associated systems 100, 120. FIG. 1A illustrates a buoyancy decreasing flow 110 of atmosphere indicative of the intake of atmosphere into the balloon 102 that decreases the volume of the lift gas and increases the mass of the system 100 to thereby decrease buoyancy of the system 100. Conversely, FIG. 1B also illustrates a buoyancy increasing flow 112 of atmosphere indicative of the evacuation of atmosphere from the ballonet that increases the volume of the lift gas and decreases the mass of the system 100 to thereby increase buoyancy of the system 100. The balloon system 122 shown in FIG. 1B includes one or more ballonet blowers 106 that similarly control buoyancy decreasing and increasing flows 110, 112 for the balloon 122.

In other examples, the atmospheric balloon systems 100, 120 include propulsion systems 108. The propulsion systems 108 provide the directed application of thrust to achieve translational movement (e.g., x, y, z) and optionally rotational movement of the systems 100, 120. The propulsion system 108 includes one or more propulsion elements configured to propel the atmospheric balloon systems 100, 120. The propulsion elements or thrusters include, but are not limited to, open or closed (ducted) fans, propellers, jets, mass discharge nozzles or the like to provide propulsion. The propulsion provided for the systems 100, 120 includes one or more of longitudinal (y) or lateral (x) propulsion, in some examples elevation propulsion (z), and optionally rotation (e.g., torque or moment). Optionally, the propulsion elements (e.g., thrusters) are articulable and provide each or one or more of these propulsion types, for instance according to control provided by the control system 130.

Referring again to FIGS. 1A, 1B the atmospheric balloon systems 100, 120 further include respective control systems 130. The control system 130 is interconnected with one or more subsystems including the propulsion system 108 and the ballast system 104. In one example, the control system 130 is one or more of an onboard or remote system relative to the balloon systems 100, 120 shown in FIGS. 1A, B. For instance, in an onboard permutation the control system 130 includes the onboard balloon control system (discussed herein) in communication with the navigation parameter system, such as a remote or ground based system. In another example, the control system 130 is a remote system, for instance provided with a companion atmospheric balloon system 100, 120, a satellite or a ground based system. In this permutation the control system 130 remotely provides guidance control to one or both of the propulsion system 108 and ballast system 104.

In one example, the control system 130 controls propulsion of the atmospheric balloon system 100, for instance with coordinated instructions provided to the propulsion elements of the propulsion system 108. As described herein, the propulsion elements include one or more of fans, propellors, jets or the like. In an example, the control system 130 operates the propulsion elements in a coordinated manner to move the system 100 in one or more directions including x, y, z directions. In another example, the control system 130 operates the propulsion elements in a coordinated manner (e.g., with a differential in power, reins or the like) to rotate the atmospheric balloon system 100 to different headings, orientation relative to the ground or air streams or the like. In still other examples, the control system 130 operates the propulsion elements to conduct contemporaneous translational and rotational movement of the atmospheric balloon systems 100, 120.

In another example, the control system 130 of the atmospheric balloon system 100, 120 is in communication with the ballast system 104, such as ballonet, shot ballast system (configured to drop weighted shot) or the like. The control system 130 operates the ballast system 104, for instance by dropping shot or operating the ballonet blower 106 move atmosphere ink) and out of the ballonet. In an example including the ballonet blower 106, the control system 130 operates the ballonet blower 106 to conduct a buoyancy decreasing flow 110 (see FIGS. 1A, B) to fill the ballonet portion of the balloon 102 (or 122 in FIG. 1B), displace some of the volume of the lift gas and increase the mass of the atmospheric balloon system 100 to decrease buoyancy of the system 100. Conversely, the control system 130 operates the ballonet blower 106 to conduct the buoyancy increasing flow 112 to evacuate the ballonet to allow the lift gas to expand and decrease the mass of the system 100 to increase the buoyancy of the system 100.

As discussed herein, the control system 130 in another example includes or is in communication with the onboard balloon control system 402. The onboard balloon control system 402 receives one or more parameter ranges, such as an altitude search range, course range, speed range or the like from a navigation parameter system 400. The onboard balloon control system 402 uses the one or more parameter ranges to conduct localized control of the atmospheric balloon system 100 (or 120) and guide the system toward a target balloon position, intervening waypoint or the like without affirmative control of the system 100 from the ground base system (e.g., the navigation parameter system 400). Instead, the onboard balloon control system 402 provides the atmospheric balloon system 100 the capability to guide itself toward a target balloon position, waypoint or the like while working within the parameter ranges provided. For instance, the onboard balloon control system 402 attempts to minimize deviations from the one or more parameter ranges through selection and guidance to an altitude, course, speed or the like that facilitates travel of the balloon to the target balloon position or waypoint.

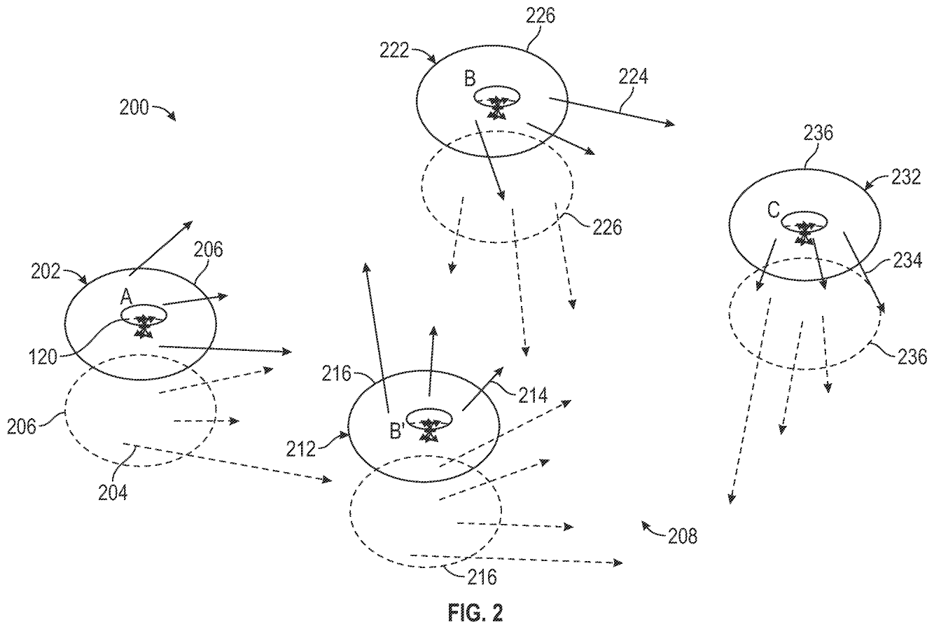

FIG. 2 is a schematic diagram plotting locations and of the atmospheric balloon system 120 at an initial location 202, target balloon position 232, with one or more waypoints 212, 222. The locations, positions or waypoints shown correspond to areas of interest, such as a coordinate origin and an associated radius and elevation (e.g., altitude). For example, as shown in FIG. 2, the initial location 202, target balloon position 232 and waypoints 212, 222 are zones (areas of interest).

Each of the initial location 202, target balloon position 232 and waypoints 212, 222 (herein sometimes referred to as positions) are illustrated as examples of locations along one or more potential routes for the atmospheric balloon system 120. As discussed herein, the locations have associated characteristics including meteorological characteristics that vary based on one or more of altitude, lateral position at the locations or the like. For instance, as shown in FIG. 2 each of the positions includes different air stream vectors that differ based on altitude and lateral position. For instance, the air stream vectors are represented with arrows and have a position in FIG. 2 corresponding to the origin of each of the vectors, magnitudes based on their lengths, and direction according to the direction of the vectors. In one example, the air stream vectors are obtained from meteorological services and are indexed to locations (such as longitude, latitude, altitude or the like). In still other examples, the air stream vectors are further indexed based on time (e.g., based on forecast airstream vectors). As described herein, the indexed air stream vectors, and optional temporally indexed (forecast) airstream vectors facilitate the generation of parameter ranges that are relayed to the onboard balloon control system to guide operation of the balloon at the balloon in contrast to a remote control system, like a ground control station.

In the example shown in FIG. 2, the initial position 202 of the atmospheric balloon system 120 includes multiple component altitudes 206. There are two component altitudes 206 in the present example, and in other examples there are two or more component altitudes. As further shown, the initial position 202 includes airstream vectors 204 at each of the component altitudes 206, and the airstream vectors 204 differ (e.g., by magnitude, direction, location or the like). As discussed herein, by guiding the propulsion and altitude of the atmospheric balloon system 120, the system 120 is moved into air stream vectors 204 to facilitate airstream (wind) assisted travel toward the target balloon position 232 (including one or more waypoints 222).

As shown in FIG. 2, the airstream vectors 204 extend in various directions, and accordingly the atmospheric balloon system 120, when positioned within the airstreams, is carried away from the initial position 202. For instance, the airstream vectors 204 at the upper component altitude 206 (solid line) extend toward each of the component waypoints 212, 222, and do so with various magnitudes. In contrast, the airstream vectors 204 of the lower component altitude 206 (dashed line) generally extend toward the waypoint 212, and do so with at least one airstream vector 204 having the largest magnitude in comparison to the other vectors at the initial position 202 (and at either altitude 206).

The airstream vectors 214, 224, 234 vary relative to each other based on altitude and position for each of the waypoints 212, 222 and the target balloon position 232. For example, each of the positions includes respective component altitudes 216, 226, 236 with different airstream vectors 214, 224, 234. With the positions, and respective component altitudes and airstream vectors the atmospheric balloon system 120 is able to travel from the initial position 202 to the target balloon position 232 through differing waypoints 212, 222 (including one or both waypoints) or potentially by traveling directly to the target balloon position 232.

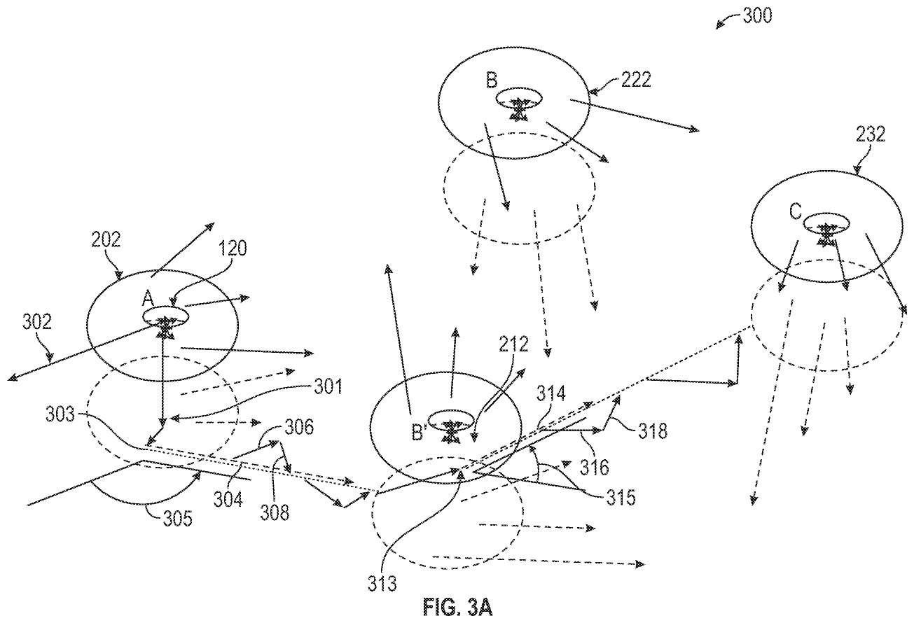

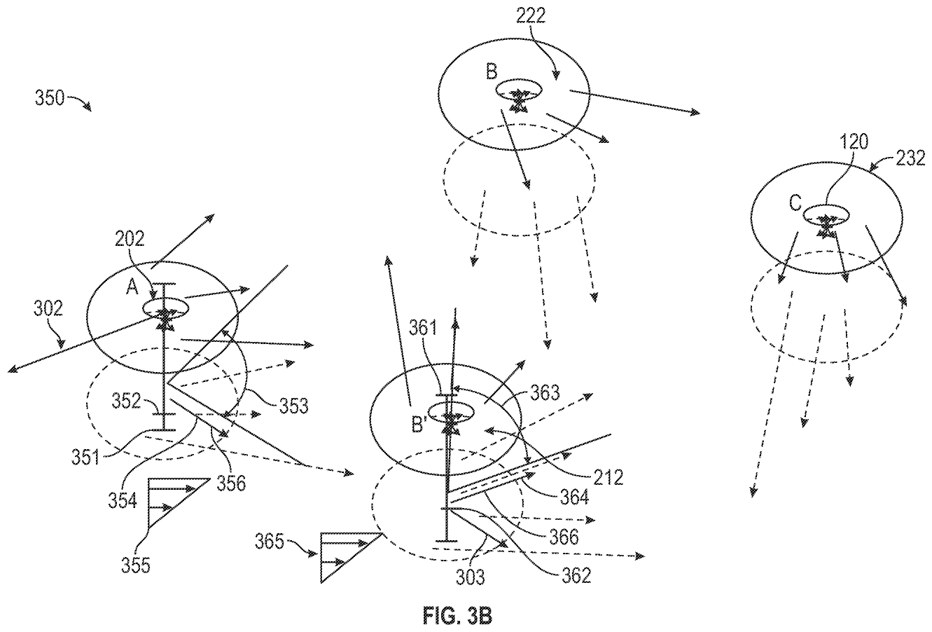

Referring now to FIG. 3A one example of parameter set point control 300 for ongoing monitoring and active control of the atmospheric balloon system 120 is illustrated. As described herein, altitude, course and speed are actively selected and implemented to move the atmospheric balloon system to a selected airstream and maintain the balloon system in the airstream. For instance, a remote controller, such as a ground station, conducts ongoing monitoring of the atmospheric balloon system 120 (e.g., its current location) and the remote controller recalculates and updates the specified altitude, course and speed settings to move the atmospheric balloon system 120 to a selected air stream. This method requires ongoing monitoring of the atmospheric balloon system (its current location), calculation of the range and bearing to the specified longitude and latitude (specified target) from the current location of the balloon system, relaying of this information to the balloon system, and implementation of updated guidance to select and move the balloon system into a corresponding air stream vector. The remote controller operates the atmospheric balloon system remotely with instructions that initiate corresponding operation of the propulsion system 108 or the ballast system 104 to guide the balloon system into the proximate air stream vector. For instance, the remote controller initiates the propulsion or ballast operations to move the atmospheric balloon system 120 into a favorable local air stream directed toward the specified longitude and latitude (the target balloon position 232 or waypoints). This method requires ongoing monitoring of the atmospheric balloon system (its current location), calculation of the range and bearing to the specified longitude and latitude (specified target) from the current location of the balloon system and active control to address deviations from one or more of a specified course, speed or altitude to guide the balloon system 120 back to the specified course, speed and altitude for instance into a selected airstream directed toward a specified target.

As shown in FIG. 3A the atmospheric balloon system 120 (referred to herein in some places as the balloon system 120) is at the initial position 202, such as an area of interest, and travel to a target balloon position 232 is desired. Intervening waypoints 212 and 222 are shown. Air stream vectors 304 are shown for each of the positions (202, 212, 222 and 232). With parameter set point control 300 discussed above and shown in FIG. 3A the balloon system 120 is actively guided toward and into selected airstream vectors 304, 314 to travel to waypoint 212 and the target balloon position 232.

For example, for the initial position 202 the balloon system 302 includes initial system kinematic characteristics 302 haying one or more of position (origin of the arrow), course or heading (direction of the arrow), speed (magnitude of the arrow). The control system selects an air stream at a lower altitude and lateral position (referred to as altitude set point 301 and position set point 303, respectively) relative to the initial system kinematic characteristics 302 shown. The parameter set point control then actively guides descent and lateral propulsion to move the balloon system 120 into the selected air stream vector 304. Additionally, the balloon system 120 actively rotates the balloon system to a course set point 305 from the direction indicated with the initial system kinematic characteristics 302 to align with the selected airstream vector 304. Accordingly, the control system actively conducts descent, lateral positioning, and rotation to achieve the specified altitude set point 301, position set point 303 and course set point 305 to place the balloon system 120 along the selected airstream 304.

Once positioned in the selected airstream vector 304 the balloon system is carried toward the selected waypoint 222. While traveling the balloon system 120 deviates relative to the selected airstream vector 304 as shown with the intermediate course deviations 306 (also referred to as perturbations) in FIG. 3A. The intermediate course deviations 306 are caused by one or more of crosswinds, updrafts, temperature changes (and associated altitude changes), weather events, day/night cycle, balloon instability or the like. As further shown in FIG. 3A intermediate course corrections 308 are conducted in an ongoing manner to actively guide the balloon system 120 to a course (or heading or both), altitude, speed or the like that positions the system within the selected airstream vector 304.

Upon arrival at the waypoint 222 another airstream vector 314 is selected that is directed to another waypoint or, in this example, the target balloon position 232. The balloon system 120 includes system kinematic characteristics corresponding to the course, heading (or both), speed and altitude at arrival at the waypoint 222. The parameter set point control 300 conducts active control of the balloon system 120 to transition the system from these characteristic values to one or more set points that position the balloon along the selected airstream vector 314. In the example shown in FIG. 3A at the waypoint 222 a position set point 313 (translation) and a course set point 315 (rotation) are implemented; an altitude set point is not included in this example because the airstream vector 314 is at the present altitude of the balloon system. Once the balloon system 120 is actively guided along the selected airstream vector 314 intermediate course deviations are experiences and the parameter set point control 300 actively guides the balloon system 120 with intermediate course corrections to counteract the deviations and reorient the system to the selected airstream vector 314.

The parameter set point control 300 thereby conducts ongoing active control of the balloon system to conduct one or more of translational (x, y, z) or rotational movement of the balloon system 120 to position the balloon system within selected airstreams and then actively controls to address deviations from the selected airstreams. In an example including a controller remote from the balloon system 120, airstream vectors are monitored, and kinematic characteristics of the system 120 are relayed to the controller to determine set points (e.g., 301, 305, 313, 315 and so on). The set points are related to the balloon system 120 and implemented to guide the balloon into the selected airstream vectors 304, 314, The balloon system 120 deviates (306, 316) during travel and kinematic characteristics such as position, heading, altitude or the like are relayed to the remote controller. The controller determines intermediate course corrections 308, 318 and relays the corrections to the balloon system 120 for implementation by way of the propulsion and ballast systems 108, 104 to reposition the system along the selected airstream vectors. Accordingly, the balloon system 120 affirmatively counteracts deviations in an ongoing manner to achieve one or more setpoints that position and maintain the system along selected airstreams. In some examples, ongoing control to implement setpoints is difficult because power intensive and sometimes continuous or near continuous control are needed. Additionally, relaying of information from the balloon system 120 to the remote controller and from the remote controller 120 to the balloon system 120 along with ongoing control are in some examples processor intensive and bandwidth intensive and may require advanced communication systems, processors or the like.

FIG. 3B provides an example of parameter range control 350 in contrast to the parameter setpoint control 300 shown in FIG. 3A. As discussed herein, parameter range control 350 determines one or more parameter ranges for use by the balloon system 120 in setting its own guidance. Instead, of relaying information back and forth between the balloon system 120 and a remote controller, in parameter range control 350 the one or more parameter ranges are determined and relayed to the balloon system 120, and the balloon system 120 then operates to select a target altitude and minimize deviations from the parameter ranges without seeking ongoing control from a remote controller, such as a ground station. Additionally, the balloon system 120 implementing parameter range control 350 operates to minimize deviations relative to the parameter ranges instead of setpoints. Accordingly, the power requirements for balloon system propulsion and altitude control are generally decreased because the balloon system 120 operates with propulsion and altitude values that position the balloon system 120 within the parameter ranges (e.g., including proximate to the edges of ranges, within the ranges or subranges or the like) in contrast to, sometimes difficult to achieve, setpoints.

FIG. 3B provides a similar initial position 202; waypoints 212, 222; and target balloon position 232 as previously shown in FIGS. 2 and 3A. At the initial position 202 the balloon system 120 has initial system kinematic characteristics 302 including one or more of an initial altitude, course or heading (or both), speed and the like. The initial position 202 has a plurality of available airstream vectors (arrows with stippling corresponding to various altitudes). In one example, the vectors are determined from meteorological services, sensors on the balloon system or the like.

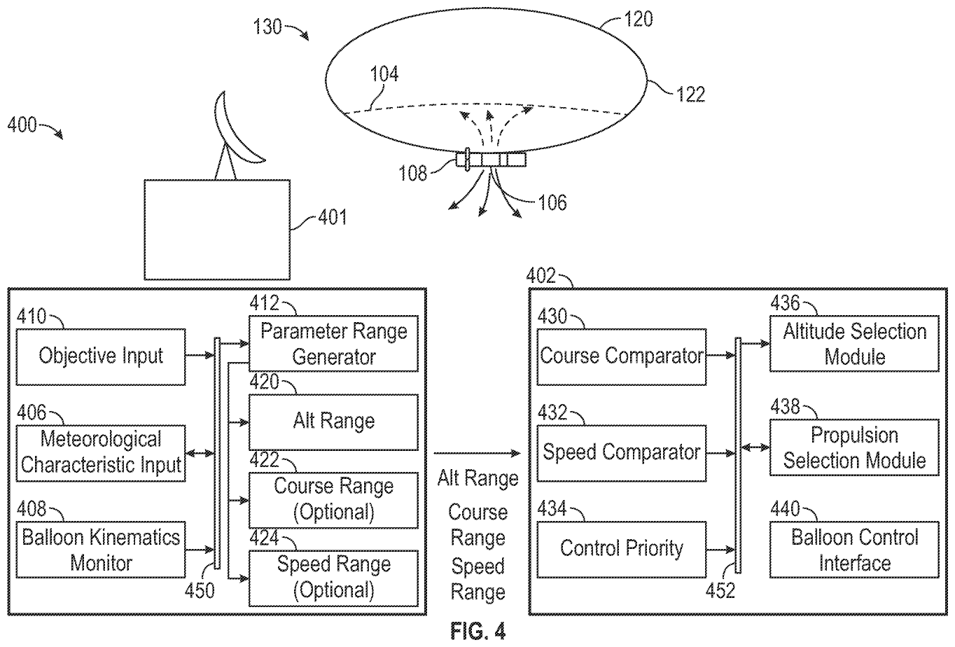

In contrast to the parameter setpoint control 300, with parameter range control 350 an airstream vector is not selected (initially) to position the balloon system 120 along. Instead, a navigation parameter system (400 in FIG. 4) determines one or more parameter ranges based on available airstreams at the initial position 202, the target balloon position 232 (and optional waypoints 212, 222) and the initial system kinematic characteristics 302 (e.g., position, course, speed or the like). In a first example, an altitude range 351 (sometimes referred to as an altitude search range) is determined with the navigation parameter system, shown with the vertical bracketed line at the initial position 202. The altitude range 351 is generated based on the available air stream vectors (or future air stream vectors for forthcoming waypoints and target balloon position when using meteorological predictions or models), balloon kinematics (present position, course or heading, speed or the like), and the one or more waypoints 212, 222 or target balloon position 232. The altitude range 351 includes a range of altitudes having airstream vectors that will carry the balloon system toward the target balloon position 232 or one of intervening waypoints 212, 222. The airstream vectors within the altitude range 351 accordingly provide one or more of course, heading, speed or the like that moves the balloon system 120 toward the target balloon position 232 or an intervening waypoint 212, 222.

In another example, the navigation parameter system determines one or more parameter ranges including one or more of the altitude range 351, a course range 353 and a speed range 355. The course range 353 is shown with the arc measurement in FIG. 3B proximate to the initial position 202. The course range 353 is a range of courses (e.g., degree range) generated based on the available air stream vectors (or future air stream vectors for forthcoming waypoints and target balloon position when using meteorological predictions or models), balloon kinematics (present position, course or heading, speed or the like), and the one or more waypoints 212, 222 or target balloon position 232. The course range provides a range of course options for the balloon system 120 in an associated airstream vector that minimizes a difference between a present balloon course and the course range 353.

The speed range 355 is shown with the triangular plot below the initial position 202 and corresponds to a range of speeds (e.g., magnitude of balloon system speed) generated based on the available air stream vectors (or future air stream vectors with predictions or models), balloon kinematics (position, course or heading, speed), and the one or more waypoints 212, 222 or target balloon position 232. The speed range provides a range of speeds for the balloon system 120 in an associated airstream to guide the balloon system 120 to an airstream vector that minimizes a difference between the present balloon speed and the speed range 355.

After the one or more parameter ranges 351, 353, 355 are generated the ranges are relayed to the balloon system 120, for instance an onboard control system (402 in FIG. 4B). The onboard control system receives the one or more parameter ranges and attempts, through one or more altitude control, propulsion control Or the like, to position the balloon system in a favorable airstream and decrease differences between the course or speed ranges relative to present balloon kinematics. For instance, the onboard control system determines a target altitude. Implementation of the target altitude moves the balloon system 120 to an altitude having one or more favorable airstreams that impart course and speed corrections to the system 120 that decreases the difference between the present kinematic values (e.g., course or speed) and the associated parameter ranges. In some examples, the propulsion system 108 provides supplemental propulsion to further decrease differences between the balloon kinematics and the associated ranges (e.g., course or speed) and thereby enhance guidance of the system 120 in combination with course and speed provided by the air stream. Optionally, the supplemental propulsion to decrease differences better positions the balloon system 120 within a favorable airstream.

In some instances, but not all, implementation of the target altitude (e.g., the ballast system 104 ascends or descends the system 120) decreases the difference between the balloon system kinematic characteristics and the associated ranges (course or speed) to zero. In other examples, the implementation of the target altitude and optional propulsion supplementing decreases the difference, but is constrained by priorities such as power consumption limits, specified arrival times, environmental perturbations (e.g., countervailing winds) or the like. The onboard control system is thereby operable to control operation of the balloon (e.g., the propulsion system 108, ballast system 104 or the like) locally proximate to the balloon without relaying information back and forth between the balloon and a remote controller, for instance with a version of parameter setpoint control 300 (FIG. 3A) using a ground station.

The target altitude 352 in FIG. 3B (shown with a hashmark along the altitude range 351) is one example of a target value determined with the onboard control system and is based in part on the altitude range 351. The target altitude 352 includes at least one airstream (having an associated direction and speed; a vector) that decreases a course difference between the present balloon course and the course range 353 or a speed difference between the present balloon speed and the speed range 355. In one example, the onboard control system initiates a survey maneuver of the balloon system 120 through the altitude range for evaluation of airstreams and selection of the target altitude 352 within the altitude range 351 that includes an airstream vector (or vectors) that decreases differences of the balloon system 120 kinematics relative to the associated ranges (e.g., course, speed or both) to facilitate travel of the balloon system 120 toward the target balloon position 232 (or optional waypoints).

The target course 354 and target speed 356 (shown with the vector arrow in FIG. 3B proximate to the initial position 202) are example values of kinematics of the balloon representing a decrease of the difference between the initial balloon kinematics (e.g., 302) relative to the course and speed ranges 353, 355. In an example system that generates the course range 353 and speed range 355 (in addition to the altitude range 351) the balloon system 120 is guided to the target course 354 and the target speed 356 by favorable airstreams at the target altitude 352 that decrease the course and speed differences, and optionally, supplemental propulsion from the propulsion system 108. In one example, neither of the target altitude, target course or target speed are configured to affirmatively align the balloon system 120 with a selected airstream. Instead, the course and speed differences relative to the course and speed parameter ranges 353, 355 are decreased and thereby position the balloon system proximate to the favorable airstream.

Because the airstreams (and optional propulsion) decrease the difference between present kinematic characteristics of the balloon system 120 and parameter ranges (e.g., course or speed 353, 355), in contrast to setpoint values, the balloon system 120 is guided toward and into airstreams without conducting ongoing and repeated corrections to guide the balloon system 120 into compliance with setpoint values. Instead, ranges of values are provided that are more readily met or approached with the propulsion system 108 and ballast system 104 of the balloon system 120 that may otherwise expend significant power attempting to achieve a discrete setpoint value.

In one example, decreasing the differences between balloon kinematic values and one or more of the course range or speed range 353, 355 with positioning in favorable airstreams and optional propulsion is conducted to position the balloon course and speed (e.g., target course and target speed) at least proximate to the edges of the course and speed ranges 353, 355. For instance, in FIG. 3B the target course 354 is along an edge of the course range 353 and the target speed 356 is proximate to an upper edge of the speed range 355. In other examples, decreasing the difference between the balloon kinematic values and the course or speed ranges 353, 355 includes decreasing differences between the kinematic values and values associated with the ranges 353, 355, such as medians, mean, quartiles, other values associate with the range including component directions or speeds of airstreams included in generation of the ranges or the like. Optionally, the ranges 353, 355 include one or more sub-ranges such, as but not limited to, refined sub-ranges of the course or speed ranges 353, 355 that tighten parameter ranges to facilitate enhanced control and guidance toward airstreams that convey the balloon system 120 to one or more of waypoints 212, 222 and the target balloon position 232. In another example, the ranges 353, 355 include one or more updated ranges 353, 355 that are re-generated (e.g. by the navigation parameter system 400 in FIG. 4) based on updated meteorological inputs, objective inputs (e.g., updated target positions) or the like. The updated (re-generated) ranges 353, 355 include, but are not limited to, narrower ranges, broader ranges or the like in comparison to the ranges 353, 355 shown in the example in FIG. 3B.

In the example shown in FIG. 3B, the parameter ranges are updated at the waypoint 212 based on the kinematic characteristics of the balloon system 120, the airstream vectors proximate to the waypoint 212, and the forthcoming waypoint (or waypoints) and the target balloon position 232. Optionally, the parameter ranges are updated prior to arrival by the balloon system 120, for instance with forecast or predicted airstream vectors. As shown in FIG. 3B each of the updated altitude range 361, course range 363 and speed range 365 are updated based on the airstream vectors present and the forthcoming waypoint 222 and target balloon position 232.

In the example shown the updated course range 363 includes a relatively wide arc because each of the waypoints 212, 222 include airstream vectors directed to the target balloon position 232. For instance, the balloon system 120 has at least one alternative route to the waypoint 222 that indirectly then carries the system 120 to the target balloon position 232. Accordingly, the onboard balloon control system is provided with a relatively wide course range 363 to use when selecting a target course 362. In other examples, the route of the balloon system including intervening waypoints 212 or 212 and 222 are determined as part of the parameter range generation (e.g., with the navigation parameter system 400), and the corresponding altitude, course and speed ranges 361, 363, 365 are generated based on the determined route.

In one example, the onboard balloon control system 402 or navigation parameter system 400 includes one or more control priorities (e.g., provided with the control priority module 434 or a similar module with the system 400). The example priorities include, but are not limited to time of arrival, power consumption specifications, waypoint specifications (e.g., waypoints that are optional or mandatory to travel) or the like. The onboard balloon control system 402 selects one or more of a target altitude, target course or target speed based on the corresponding parameter range (or ranges with multiple parameter ranges) and optionally the one or more control priorities. In another example, the navigation parameter system 400 generates the altitude, course and speed ranges based on the control priorities. For instance, a control priority module is included with the system 400, and is a supplemental input to the parameter range generator 412 when the altitude, course and speed ranges are determined (e.g., with modules 420, 422, 424).

For instance, with a control priority specifying a relatively later time of arrival at the target balloon location 232 the onboard balloon control system 402 selects a target course relative to the course range that guides the balloon system 120 through the waypoint 222 (B) (from 212), such as along an airstream vector directed toward the waypoint 222. Travel through the waypoint 222 ensures arrival at or more proximate to the specified (later) time of arrival in contrast to arrival outside of the arrival time should the balloon system 120 instead directly travel from the waypoint 212 to the target balloon location 232. In the converse example, the navigation parameter system 400 (e.g., remote from the balloon system) generates altitude, course and speed ranges that are based on airstream vectors that favorably direct the balloon system toward the waypoint 222, and the onboard system 402 then selects a target altitude having a favorable airstream that decreases course and speed differences to direct the balloon system 120 toward the waypoint 222.

In another example, the control priority includes a power consumption specification intended to minimize (e.g., limit or decrease) the power consumed by the balloon system 120, for instance with the ballast system 104 and the propulsion system 108. The onboard control balloon control system 402 with this priority in one example selects target altitudes and decreases course and speed differences in a manner that minimizes power consumption for the balloon system 120 while guiding the balloon system 120 into an airstream that carries the system to the specified location, such as the target balloon position 232. For example, decreasing of differences (e.g., with supplemental propulsion) relative to the ranges is conducted less aggressively and accordingly more of the difference between the present kinematics of the balloon system (e.g., course, speed, altitude) relative to the associated parameter range or ranges may remain. Accordingly, the balloon system 120 may move into an airstream that is less than ideal because additional propulsion to move the system into the airstream is prohibited with the power consumption specification. In practice the onboard balloon control system 402 less aggressively uses propulsion to move the balloon system 120 into an airstream. For instance, limits on power consumption cap power available to the propulsion system 108 and thereby decrease potential rates of change of the differences in the manner of a lesser control gain. The balloon system 120 with this priority may have a less definite time of arrival or circuitous path to the target balloon position 232 (that also decreases power consumption) in comparison to an airstream at a significantly different altitude or that requires significant propulsion to supplement course and speed otherwise provided by the airstream. In another example, the power consumption specification is provided as a control priority to the navigation parameter system 400 and is used as an input of the parameter range generator 412. The altitude, course and speed ranges generated may have one or more of broader or tighter ranges (compared to those shown in FIG. 3B) and the variation is provided in part by the power consumption specification.

In still other examples, multiple priorities are provided and weighted by the onboard control system 402 to flexibly guide selection of target altitude, and decreases of course and speed relative to the course range or speed range. The multiple priorities refine the target altitude, aggressiveness of the course and speed propulsion supplements where applicable (and the corresponding degree of decrease of the present balloon kinematics relative to the associated parameter range or ranges). In other examples the priorities are provided to the navigation parameter system 400 (e.g., a remote system) to refine generation of the parameter ranges. In operation, the onboard control system 402 selects one or more target altitude, aggressiveness of course or speed difference decreases (e.g., gains, rates of change or the like) for guidance of the balloon system 120 to decrease differences between present balloon kinematics (e.g., altitude, course or speed) and the associated altitude range, course range or speed range. The implementation of the target values through propulsion and ballast control guides the balloon system 120 into airstreams (e.g., one of the bases for generation of the parameter ranges). The priorities may refine the increment of the control (e.g., the degree of decrease of the difference, gain or the like), amount of altitude change conducted, direction of control (e.g., turning to one or an opposed edge of a course range, turning into the arc of the course range), the degree of propulsion to supplement the velocity otherwise imparted by the airstream or the like.

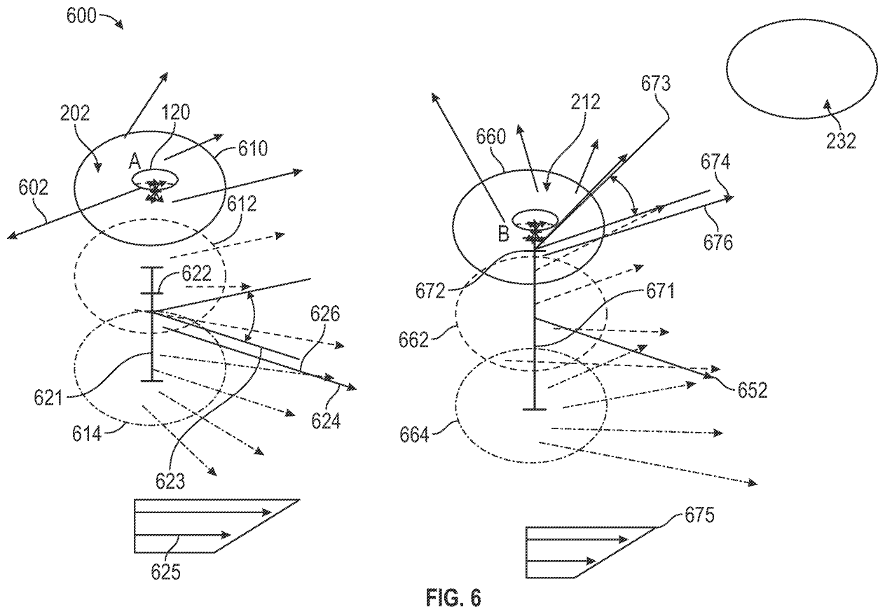

FIG. 4 is a schematic illustration of one example of a control system 130 that provides parameter range control 350 as shown in FIG. 3B and FIG. 6. The control system 130 is operable to provide one or more parameter ranges to the balloon system 120, and the system 130 including an onboard component of the control system 130 sets target values locally (e.g., at the balloon system) based on the parameter ranges. As shown in FIG. 4, the control system 130 in this example includes a navigation parameter system 400 and an onboard balloon control system 402. In the example, the navigation parameter system 400 is remote relative to the balloon system 120 (e.g., a ground station, companion balloon, satellite, cloud based control system or the like). In another example, the navigation parameter system 400 and the onboard balloon control system 402 are consolidated, for instance as part of the balloon system 120.

In an example including the navigation parameter system 400 as a remote component from the remainder of the control system 130 the navigation parameter system 400 is optionally provided at a remote station 401, such as a ground station, companion balloon, satellite, cloud based control system or the like. The navigation parameter system 400 is configured to generate one or more parameter ranges such as the altitude range (also referred to as the altitude search range), course range or speed range for use with the balloon system 120 control as discussed herein.

Referring again to FIG. 4, in the example shown the navigation parameter system 400 includes an interface 450 that provides intercommunication between one or more elements or modules (e.g., circuits, hardwired logic controllers, computer readable media or the like). Various modules are provided for delivery or intake of characteristics or values that facilitate generation of the one or more parameter ranges. In the example shown, the navigation parameter system 400 includes an objective input 410, meteorological characteristic input 406 and a balloon kinematics monitor 408. The objective input 410 provides one or more locations or positions of interest including, but not limited to, the target balloon position 232, initial position 202, and one or more intervening waypoints 212, 222 (shown in FIGS. 2, 3A and 3B). Optionally, the objective input 410 provides one or more non-position based objectives such as specified arrival times, specified station seeking times or durations (also referred to as station keeping) or the like.

The meteorological characteristic input 406 provides air stream vector input and optionally other meteorological information (pressure, temperature, forecast information or the like) to the control system 130 to facilitate generation of the parameter range (or ranges). The input 406 includes airstream vectors and associated values (magnitude, origin, direction or the like) proximate to the positions provided by the objective input 410 (e.g., target balloon position 232, initial position 202, waypoints 212, 222 or the like). In other examples, the input 406 provides airstream vectors at locations between positions of interest to generate parameter ranges and facilitate inter-location selection of target altitudes, courses or speeds (also between positions of interest). The meteorological characteristic input 406 is in one example provided by a meteorological database or service (e.g., NWS), forecasts, predictions, models or the like. In other examples, airstream vectors or the like are measured by sensors on the balloon system 120, other vehicles such as other balloons, ground stations or the like, and input to the meteorological characteristic input 406.

In still other examples, the meteorological characteristic input 406 provides airstream vectors at various times in addition to locations to facilitate temporal as well as positional generation of parameter ranges and target values for the ranges. Accordingly, positions, such as one or more of the initial position 202, waypoints 212, 222, and the target balloon position 232 (as well as intervening locations) may have an array of airstream vectors at various positions, and at each of the various positions multiple airstream vectors are indexed according to their values (e.g., direction and magnitude) including time of occurrence. The indexed airstreams are in one example an airstream function (or functions) that varies based on time for each position indexed. The indexing of airstream vectors by position and time facilitates the generation of parameter ranges and targets based on airstream vectors proximate to the position of interest and present at a time of arrival (or future time of arrival) by the balloon system 120.

The navigation parameter system 400 further includes a balloon kinematics monitor 408 that obtains or determines one or more of balloon position (e.g., longitude, latitude, altitude), course, heading or speed and optionally other values associated with the balloon system 120 including, but not limited to, power available, power consumption or the like. The monitor 408 includes one or more sensors or is in communication with one or more sensors that monitor characteristics of the balloon system 120. The sensors include one or more of global positioning system (GPS) sensors, gyroscopic sensors or air data sensors (e.g., pressure sensors, altimeter or the like). As previously discussed, the balloon kinematics are an example component for generation of the parameter ranges. In another example, the balloon kinematics provide values for comparison with the parameter ranges to determine deviation of the balloon system 130 from the parameter ranges, and accordingly to generate target values (e.g., target altitude, target course or target speed proximate to the course or speed ranges) to decrease the differences and thereby move the balloon system 120 into airstreams that assist in moving the balloon to target positions. In other examples, the target values are determined and implemented while the balloon system 120 is within an airstream, for instance to refine position within the airstream, provide propulsion or a course that decreases travel time to a position (in concert with the airstream velocity) or the like.

The inputs from one or more of the objective input 410, meteorological characteristic input 406 or balloon kinematics monitor 408 are provided through the interface 450 to a parameter range generator 412. In another example, control priorities such as preferred routes, power consumption specifications, time of arrival or the are provided as supplemental inputs for range generation. The parameter range generator generates the one or more parameter ranges including, but not limited to, an altitude search range (also referred to as an altitude range), course range or speed range based on the inputs 406-410. Examples of the various parameter ranges are shown in FIG. 3B and described herein. In a first example, the altitude search range is generated at the altitude range module 420. As shown in FIG. 3B, the altitude ranges 351, 361 include a range of altitudes having airstream vectors directed toward potential forthcoming locations including waypoints 212, 222 and the target balloon position 232. In an example, having multiple altitudes with airstream vectors that may guide the balloon system 120 toward one or more of the locations, the altitude range is spans between at least those altitudes. In an example, having a smaller number of altitudes with favorable airstream vectors the altitude range is correspondingly smaller.

In one example, the navigation parameter system 400 generates the altitude range with the module 420 and the altitude range is provided to the onboard balloon control system 402 for selection of a target altitude, and additional control to set and implement target course and target speed (e.g., without correspond course and speed ranges from the parameter system 400). In another example, the navigation parameter system 400 also includes a course range module 422 and a speed range module 424.

In an example with the navigation parameter system 400 having the course range module 422 a range of courses (e.g., course ranges 353, 363 in FIG. 3B) are generated based on the available air stream vectors (or future air stream vectors for forthcoming waypoints and target balloon position, for instance with predictive models) in combination with balloon kinematics (position, one or both of course or heading, or speed), and one or more waypoints 212, 222 or target balloon position 232. The generated course range corresponds to an arc having airstream vectors that will guide the balloon system 120 toward a forthcoming specified location (e.g., the target balloon position, waypoints or the like). The onboard balloon control system 402 positions the balloon system 120 at the target altitude to decrease the course difference between the balloon system kinematic present course and the courage range with the favorable airstream. For instance, the favorable airstream at the target altitude causes course (and speed) changes that, decrease differences between the present kinematics and the course range (and speed range). In an example, the system 402 supplements the decrease in difference because of the airstream with additional propulsion from the propulsion system 108 to further decrease the course difference. In one example, the supplemental propulsion in combination with the airstream adjusts the balloon system kinematics to the target course and target speeds shown in FIG. 3B (e.g., along or within the course range). Optionally, with the balloon system 120 present (actual) course already inside or guided to inside the course range with an airstream vector, the course range is refined and updated with the course range module 422 to provide a tighter (or broader) course range to further guide the selection of a target course by the onboard balloon control system 402 toward a favorable airstream vector.

In another example, the navigation parameter system 400 includes the speed range module 424. The speed range module 424 generates a speed range, or magnitude of balloon system speed, propulsion or the like, based on the available air stream vectors (or future air stream vectors for forthcoming waypoints and target balloon position, with predictive models), balloon kinematics (position, one or both of course or heading, or speed), and one or more waypoints 212, 222 or target balloon position 232. The speed range provides a range of speeds (in combination with a course range) to guide control of the balloon system 120 toward airstream vectors that will carry the balloon system toward a forthcoming specified location. Positioning of the balloon system 120 at the target altitude with the onboard balloon control system 402 minimizes the difference (in speed) between a present balloon speed and the speed range. Optionally, supplemental propulsion is provided with the propulsion system 108 (e.g., power output, rpms or the like) to further decrease any remaining difference between the balloon speed (a kinematic value) and the speed range. In a similar manner to the course range, with a present speed of the balloon system 120 within the speed range, the speed range is optionally refined and updated with the speed range module 424 to provide a smaller speed range for further guidance of target speed selection. As described herein the selection of the target course (and target speed) is translated into propulsion (e.g., course or heading and propulsion power) to guide the balloon system 120 into favorable airstreams and optionally to assist with travel of the system 120 along the airstreams.

In another example, after guidance of the balloon system 120 into a favorable airstream (directed toward the forthcoming specified position) each of the altitude range, course range, speed range and the associated target values for each are refined to supplement the course and speed guidance provided by the airstream vector. Optionally, the refinements of the balloon system 120 speed, course, altitude or the like thereby enhance travel with respect to the airstream vector by itself. For example, the balloon system 120 is controlled with ranges and associated target values to arrive at a specified position at varying times, from varied directions, with varied speed or the like including, but not limited to, decreasing a time of arrival, increasing a time of arrival (e.g., for station keeping or in anticipation of favorable airstream vectors at the later time of arrival), or one or more of approaching a position (waypoint or target balloon position) from a direction or with a speed that assists in transitioning to a next airstream vector.

Referring again to FIG. 4B the onboard balloon control system 402 of the control system 130 configured to conduct parameter range control (as shown in FIG. 3B) is shown as a component of the balloon system 130. The onboard balloon control system 402 determines target values for balloon operation (e.g., target altitude, target course, target speed or the like) from parameter ranges and balloon kinematics. The target values are determined relative to the one or more associated altitude, course or speed ranges, and decrease a difference between present kinematic characteristics for the balloon system 120 relative to the associated ranges. The balloon system 120 that implements the target values is guided toward one or more airstream vectors that convey the balloon system to a specified position.

As shown in FIG. 4, the altitude selection module 436 selects a target altitude having one or more airstream vectors having direction and speed that decrease one or more of the course difference or speed difference. In one example, a survey maneuver is conducted within the altitude range 351, 361 in FIG. 3B) generated with the altitude range module 420 by the balloon system 120 to evaluate air stream vectors with one or more of direction or speed that decrease (e.g., optimally decrease relative to other vectors) course or speed differences between the present balloon kinematic characteristics (e.g., heading, course, speed) and associated ranges at the altitudes within the range. The onboard system 402 selects the target altitude according to the analysis of decreased difference(s). For instance, a target altitude is selected based on the altitude having an airstream vector (or vectors) that generate an associated course and speed range that have decreased difference relative to the present balloon course and speed. The corresponding altitude accordingly facilitates guidance of the balloon system 120 into the associated airstream vector with less active guidance by the system 120 (e.g., significant active course and speed changes are unnecessary to guide the balloon into the airstream). In another example, altitudes that do not have airstream vectors that are favorable to guidance of the balloon system 120 to a waypoint or target balloon position are not included in the altitude range, and are accordingly not available for selection of a target altitude.

The onboard balloon control system 402 in another example is configured to determine a target course and a target speed. Optionally, as discussed above the system 402 selects a target altitude from an altitude range from the navigation parameter system 400, and the target course and target speed are selected (with the onboard system 402) to guide the balloon system 120 into an airstream vector at the target altitude.

In another example, the onboard balloon control system 402 receives one or both of a course range and a speed range from the navigation parameter system 400, and the onboard system 402 selects a target course and a target speed relative to the associated ranges. As shown in FIG. 4 in this example, the onboard balloon control system 402 includes a course comparator 430 that determines a course difference between the balloon course (e.g., sensed with the kinematics monitor 408) and the course range determined with the course range module 422. As discussed herein, the course range includes at least one airstream vector directed toward a forthcoming position such as a waypoint or target balloon position.

Similarly, the onboard balloon control system 402 includes a speed comparator 432 that determines a speed difference between the balloon speed (e.g., sensed with the kinematics monitor 408) and the speed range determined with the speed range module 424. The speed range provides a range of speeds for guidance of the balloon system to an available airstream vector. The target speed is selected relative to the speed range to decrease a difference between the present speed of the balloon system 120 and the speed range, and when implemented moves the balloon system 120 into the airstream vector. In another example, the speed range is representative of the speeds (e.g., wind speeds) of the available airstream vectors, and the target speed decreases the difference between the present speed of the balloon system 120 and the airstream vector speeds (the speed range). Once the balloon system 120 is within the airstream vector and carried at the vector speed the difference is small (or zero) between the actual speed of the balloon system (sensed with the kinematics monitor 408) and the speed range, and accordingly the target speed that otherwise supplements the airstream speed is negligible.

As further shown in FIG. 4 a control priority module 434 is optionally included with the onboard balloon control system 402. The control priority module 434 provides one or more priorities for balloon system 120 operation including, but not limited to propulsion and ballast system control, In one example, the control priority module 434 includes a priority of target selection, such as altitude target selection as a first priority, course target selection as a second priority and speed target selection as a third priority. In an example, including altitude target selection as a higher priority an associated priority may be power preservation or saving. The onboard control balloon control system 402 with this priority in one example selects altitude, course and speed targets that minimize power consumption for the balloon system 120 while guiding the balloon system 120 into an airstream that carries the system to the specified location, such as the target balloon position 232. For instance, a target altitude is selected and implemented before implementation of a target course or target speed to minimize power consumption with propulsion effort (e.g., course changes and acceleration and deceleration).

In other examples power preservation or saving priorities are implemented with less aggressive altitude, course or speed target values. In this example, the difference between the present kinematics of the balloon system (e.g., course, speed, altitude) relative to the associated parameter range or ranges remains after achieving the target values. In practice targets are chosen that guide the balloon system 120 into an airstream that may provide a less definite time of arrival or circuitous path to the target balloon position 232 (that also decreases power consumption) in comparison to an airstream at a significantly different altitude or that requires significant propulsion to move the balloon system 120 to the airstream (e.g., through rotation or translation relative to the associated course and speed ranges). Conversely, where time of arrival is designated a higher priority the control priority module 434 facilitates the setting of aggressive altitude, course and speed target values where necessary to achieve a specified time of arrival.

In still other examples, multiple priorities are provided and weighted by the control priority module 434 to flexibly guide selection of altitude, course and speed targets relative to the associated altitude search range, course range or speed range. The multiple priorities refine the target altitude, target course or target speed (and the corresponding degree of decrease of the present balloon kinematics relative to the associated parameter range or ranges). In other examples the priorities are provided to the navigation parameter system 400 (e.g., a remote system) to refine generation of the parameter ranges. The priorities may refine the increment of the control (e.g., gain or the degree of decrease of the difference), amount of altitude change conducted, direction of control (e.g., turning to one or an opposed edge of a course range, turning into the arc of the course range), the degree of propulsion to supplement the velocity otherwise imparted by the airstream or the like.

A propulsion selection module 438 receives the course difference and the speed difference from the associated comparators 430, 432 (e.g., by way of the interface 452) along with the corresponding parameter ranges from the navigation parameter system 400 and selects one or more of target course or target speed that decrease the respective course and speed differences. That target course or target speed selected with the module 438, when implemented, guide the balloon system 120 into a favorable airstream, for instance at the target altitude and within the course range. In another example, the target course or target speed, when implemented, supplement the course and speed provided by the favorable airstream vector to the balloon system 120. For instance, propulsion implemented for course and speed targets supplements the speed of the balloon system 120 in the airstream vector and facilitates an earlier time of arrival at a waypoint or target balloon position.

The balloon control interface 440 interprets one or more of the target altitude, target course or target speed and implements control of the balloon system to achieve the targets. For instance the balloon control interface 440 is in communication with each of the propulsion and ballast systems 108, 104 and operates the systems to conduct course and speed control and altitude control to achieve the specified target values. In one example, the balloon control interface 440 apportions propulsion values (e.g., power, rpms, thrust values or the like) to propulsion elements or thrusters to conduct course control and speed control. In another example, the balloon control interface 440 operates one or more of the propulsion elements (e.g., articulable propulsion elements) or the ballast system 104 (e.g., a ballonet or the like) to conduct altitude control.

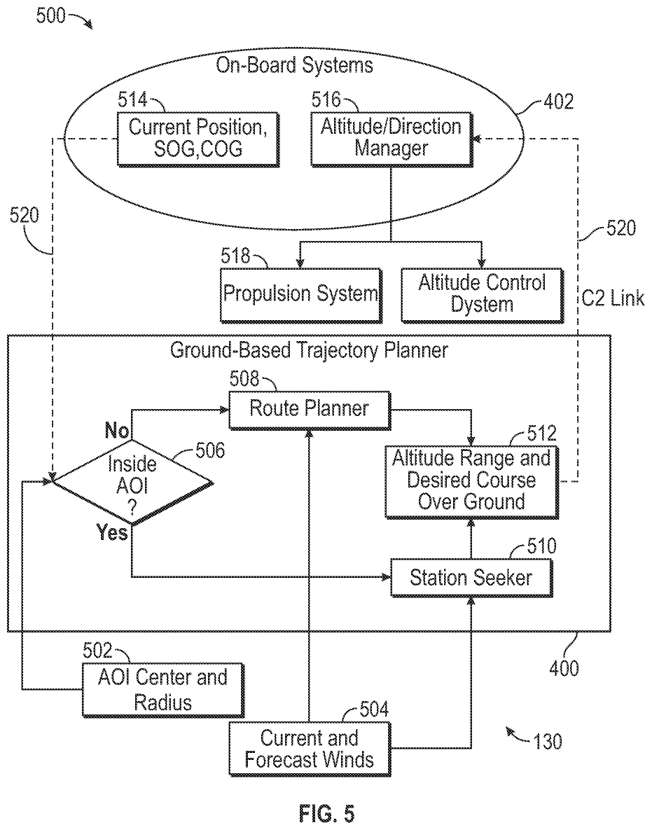

FIG. 5 is a schematic 500 of control system 130 architecture that provides parameter range control (as shown in FIG. 3B). As in FIG. 4, the schematic 500 includes a navigation parameter system 400 that generates one or more parameter ranges, and an onboard balloon control system 402 that selects target values for one or more characteristics associated with the parameter ranges including, but not limited to, altitude, course or speed.

The navigation parameter system includes an objective input 502 that provides one or more specified positions to the system 400. In some examples, the specified positions include waypoints, target balloon positions or the. In another example, the specified position includes an area of interest (AOI) such as its center position, radius or the like. The center position and radius form a corresponding circle or cylinder for one or more of the target position, waypoints, and initial balloon position. Optionally the objective input values provided by the objective input include additional information including, but not limited to, specified arrival times, station seeking times or the like.

A position comparator 506 compares the present position of the balloon system (e.g., system 120) relative to the objective input 502. In an example, the position of the balloon system 120 is provided by the balloon system kinematics sensor 514 having one or more sensors configured to monitor (determine, measure, obtain or the like) one or more of balloon position, balloon course, balloon speed or the like (collectively balloon kinematics). Optionally, the balloon kinematics are relayed from the sensor 514 to the balloon kinematics monitor 408 shown in FIG. 4. As shown in FIG. 5, the balloon kinematics are provided to the position comparator 506 with a communication bridge 520 including, but not limited to, wireless (cellular, radio, laser) communication systems, or wired (e.g., with both systems 400, 402 onboard the balloon system). The position comparator 506 compares and determines a deviation between the balloon position and the objective input, including one or more positions such as the initial balloon position, target balloon position and optional waypoints.

With the example navigation parameter system 400 the comparison at the position comparator routes parameter range generation between a route planner module 508 or a station seeking module 510. Each of the modules 508, 510 are example components of the parameter range generator 412 previous described and shown in FIG. 4. The modules 508, 510 generate associated parameter ranges that are relayed to the onboard balloon control system 402 and used for the determination of associated target values (e.g., altitude, course, speed or the like) as discussed herein.

With the route planner module 508 parameter ranges are generated to guide propulsion and associated movement of the balloon system 120 into one or more available airstreams (e.g., provided with the meteorological input 504) to convey the system 120 to forthcoming positions such as waypoints, a target balloon position or the like. The route planner module 508, as a component of the parameter range generator 412, is in communication with the meteorological input 504 (referred to as 406 in FIG. 4) and determines parameter ranges based on the balloon kinematics (e.g., form the balloon system kinematics sensor 514) and the available airstream vectors. The parameter ranges are illustrated in FIG. 5 as the output parameter ranges 512, and are communicated to the onboard balloon control system 402, for instance with the communication bridge 520. In one example, the parameter range conveyed includes an altitude range (also referred to as an altitude search range) used by the onboard balloon control system 402 for selection of a target altitude having airstream vectors that are favorable for guidance of the balloon system 120 to a specified position. Optionally, a specified course, such as a course over ground (in contrast to parameter and speed ranges), is provided with the altitude range to the onboard balloon control system 402. In another example, one or more of altitude, course and speed ranges are provided to the onboard balloon control system 402.

The station seeking module 510 is another example of a component of the parameter range generator 412 of FIG. 4. The module 510 receives meteorological information, such as available airstream vectors, from the meteorological input 504 and balloon system kinematics information (e.g., from the sensor 514). In the example of the station seeking module 510 the parameter ranges generated, including one or more of altitude, course or speed, are configured to facilitate station seeking (or station keeping) of the balloon system 120 and thereby maintain the balloon system position at a specified position, for instance within the AOI of a present position, or a position the system 120 will occupy at a future arrival.

In each case, station seeking or route planning, the associated parameter range or ranges are provided as the output parameter ranges 512 and relayed to the onboard balloon control system 402. The onboard balloon control system 402 includes a control coordinator 516 that determines target values relative to the relayed parameter ranges. For instance, the control coordinator 516 corresponds to one or more of the altitude selection module 436 or the propulsion selection module 438 shown in FIG. 4. The control coordinator 516 selects one or more target values based on the received parameter ranges. For example, the control coordinator 516 determines one or more of a target altitude, target course or target speed. Optionally, the determination (or determinations) are conducted based on one or more survey maneuvers within the altitude range, for instance, to evaluation potential favorable airstream vectors at altitudes within the altitude range.

In another example, the navigation parameter system 400 provides fewer parameter ranges, such as an altitude range with an optional target course or target speed. In this example, the onboard balloon control system 402 determines a target altitude, and then implements propulsion control to achieve one or both of the target course or target speed without determination of target values based on parameter ranges).

Optionally the control coordinator 516 includes one or more additional inputs to facilitate determination of target values. One example of an additional input includes the control priority module 434 in FIG. 4. The control priority module 434 includes one or more priorities to facilitate the refined selection of target values. In one example, the control priority module 434 prioritizes the initial form of target selection, for instance, prioritizing altitude range (ballast control) and the associated target altitude selection before selection of a target course or target speed (lateral propulsion). In other examples, the control priority module 434 includes other priorities including, but not limited, to time of arrival, power saving or the like that affect selection of target values of one or more altitude, course or speed. As further shown in FIG. 5, the onboard balloon control system 402 includes control interfaces 518 for the implementation of target values by one or more of the ballast system 104, propulsion system 108 or both. In FIG. 4 the control interfaces 518 are shown consolidated as the balloon control interface 440.

FIG. 6 is a detailed schematic example of the parameter range control 600 previously shown in FIG. 3B including guidance of the balloon system with parameter ranges and implementation of one or more of altitude, course and speed changes to position the balloon system 120 within favorable airstreams between the initial position 202 and the target balloon position 232. The navigation parameter system 400 generates one or more of altitude, course or speed ranges based on input characteristics (balloon system kinematics, target locations, air stream vectors). The ranges are provided to the onboard balloon control system 402, and the system 402 selects a target altitude that decreases a difference between present balloon kinematics, such as course and speed, relative to the associated ranges (e.g., the target altitude include one or more airstreams that are favorable to decreasing the difference). Guidance to a target altitude having a favorable airstream decreases the differences. In one example, positioning of the balloon system within the favorable airstreams decreases the difference between the balloon system kinematics and the course and speed ranges. In another example, positioning of the balloon system within the favorable airstream decreases the differences, and supplemental propulsion is supplied to further decrease the differences. The onboard system 402 provides refined control relative to the parameter ranges generated with the navigation parameter system 400 to minimize repeated back and forth communication, updating, and revision of control instructions and provides flexibility for the balloon system to operate relative to the parameter ranges. Additionally, the onboard system 402 further decreases differences between kinematic values of the balloon system, such as course and speed, relative to the course range and speed range, with refined control of the balloon system course and speed within the ranges themselves (e.g., at a subrange of the course range, subrange of the speed range or the like).

Referring first to the initial position 202 of the balloon system 120 various parameter ranges are shown including, but not limited to one or more of an altitude range 621, a course range 623 and a speed range 625. In one example the parameter ranges are generated by a remote system, such as the navigation parameter system 400 shown in FIGS. 4 and 5. One or more of the parameter ranges are provided to the balloon system and the onboard balloon control system 402 for conducting guidance of the balloon system (e.g., to decrease one or more differences between the balloon system kinematics and the associated range or ranges). The one or more parameter ranges are provided to the balloon system and the onboard system 402 to guide the balloon system into one or more favorable air streams, for instance air streams that minimize differences between the present balloon system kinematics (e.g., altitude, course, speed or the like) and the associated parameter ranges.

The altitude range 621 includes various altitudes (e.g., component altitudes 610, 612, 614) having favorable air stream vectors that decrease one or more of course difference or speed difference. Positioning of the balloon system 120 at one or more target altitudes within the range 621 guides the balloon to courses and speeds that approach the course or speed ranges or position the balloon system (course and speed) within the course or speed ranges. Approach of the balloon system course or speed toward or into (within) the associated course or speed ranges corresponds to decreasing the difference between the course or speed kinematics of the balloon system (e.g., the present course or speed of the system) relative to the course or speed ranges.

The course and speed ranges 623 and 625 are also illustrated in FIG. 6, The course range 623 corresponds to a range (an arc measurement) of courses for the balloon system 120 that, when achieved, represent positioning of the within a favorable airstream and conveyance of the balloon system 120 to a target balloon position or intervening waypoint. In one example, the course range, when achieved, positions the balloon system in airstreams that convey the balloon system spatially to one or more destinations. The course range 623 is based on available air stream vectors for at least one component altitude 610, 612, 614 within the altitude range, balloon kinematics and locations of interest (station seeking location, waypoint, target balloon position, or the like). In some examples, the course range is sufficiently broad (wider arc) to include multiple potential airstreams and waypoints to facilitate route choice by the system 402 in choosing a route (e.g., to a target balloon position 232). For instance, route choice and the generation of the course range is conducted according to one or more priorities including power consumption (requires the least power from the balloon system), specified time of arrival (which route facilitates the TOA), and way point priority. In other examples, the control priorities (434 in FIG. 4) are provided or are stored in the navigation parameter system 400 (instead of or in addition to the system 402) to facilitate generation of the course range. In another example, the course range includes a course corresponding to the course of an airstream toward a target balloon position or intervening waypoint. One or more of altitude or propulsion control move the balloon into the air stream and optionally provide supplemental course (or speed) control to further decrease the difference relative to the course range (or speed range).

In a similar manner, the speed range 625 includes a range of speeds for the balloon system 120 that, when achieved, indicate the positioning of the balloon system 120 within a favorable airstream that will convey the balloon system to a target balloon position or intervening waypoint at a time of arrival or range of time for arrival (collectively a time of arrival). The speed range 625 is generated from and based on available air stream vectors, balloon kinematics and locations of interest (e.g., waypoints, target balloon position or the like).

In operation, the balloon system 120 includes initial system kinematic characteristics 602 as shown with the vector arrow at the initial position 202. The balloon system including the onboard balloon control system 402 conducts a survey maneuver through all or a portion of the altitude range 621. A target altitude 622 is determined by the control system 402 that includes one or more favorable airstreams directed toward a specified location. For instance, the target altitude 622 includes at least one airstream vector that decreases one or both of course difference or speed difference of the balloon system e.g., the kinematic characteristics 602) relative to the associated course or speed ranges 623, 625. Optionally, the survey maneuver through component altitudes 610, 612, 614 in the altitude range 621 compares updated balloon kinematic characteristics 602 or rates of decrease of the differences of the characteristics 602 relative to the parameter ranges at the altitudes to select an altitude that best accomplishes achieving one or more of the course range or speed range. The resulting attitude is the target attitude.

At the target altitude the balloon system 120 is positioned within the favorable airstream (e.g., by altitude control with the ballast system 104, laterally with the propulsion system 108 or both), and the favorable airstream imparts speed and course guidance to the balloon toward a specified position. The differences of the balloon kinematic characteristics 602 decrease relative to the associated parameter ranges (e.g., course or speed ranges) as the favorable airstream at the target altitude conveys the balloon system 120 along the airstream course and imparts its associated speed to the system 120 represented with the target course 624 and target speed 626 in FIG. 6.

In another example, in a situation that the airstream vector at the target altitude partially achieves the course range or speed range (e.g., fails to achieve a difference between kinematics such as course or speed with the parameter ranges) the onboard control system 402 supplies supplemental course or speed with the propulsion system 108. In another example, if the propulsion system 108 is unable to achieve control of the balloon system to achieve the course or speed ranges, for instance because of power usage priority or insufficient propulsion, the onboard control system 402 continues with a survey maneuver to select a new target altitude or updated parameter ranges are generated by the navigation parameter system 400 and provided to the onboard system 402 for reimplementation of the survey maneuver and selection of a target altitude and associated favorable airstream.

Optionally, in a situation that the airstream vector at the target altitude achieves the course range or speed range (e.g., the difference between kinematics relative to ranges decreases to zero) the onboard control system 402 supplies course or speed supplements with the propulsion system 108. For example, the system 402 and the propulsion system 108 control the balloon course or speed to midpoints of the associated ranges, quartiles of the ranges, subranges or the like. In another example, the course or speed ranges 623, 625 are tightened to initiate supplemental control to a subrange of the initial parameter range (e.g., through altitude change to a more favorable airstream, propulsion supplementing or the like). In still another example, the navigation parameter system 400 re-generates the control or speed ranges 623, 625 to initiate supplemental control of the balloon system (e.g., through altitude change to a more favorable airstream, propulsion supplementing or the like). In the context of the present subject matter decreasing the difference of the balloon system kinematics relative to the associated ranges includes balloon control into and within the parameter ranges for course or speed.

While traveling to the waypoint 212 the balloon system 120 is conveyed by the favorable airstream without control provided by the onboard system 402 in an example (e.g., other than supplemental propulsion as discussed herein above). In another example, the system 402 continues to conduct a survey maneuver while traveling between positions to select target altitudes with airstream vectors that better comport with the course or speed ranges 623, 625. The system 402 then conducts supplemental propulsion if needed to satisfy the course range or speed range (e.g., decrease the difference between the balloon kinematic course or speed and the associated course or speed ranges).

The generation of the parameter ranges is conducted for the waypoint 212 in a similar manner to the initial position 202. An updated altitude range 671 is generated with the navigation parameter system 400 based on available airstreams at one or more component altitudes 660, 662, 664), the waypoint 212 position and the forthcoming position, the target balloon position. Updated course and speed ranges 673 and 675 are similarly generated.

The onboard balloon control system 402 initiates a survey maneuver within the altitude range 671 and selects the updated target altitude 672 having one or more favorable airstreams that will decrease the difference between the present balloon kinematic characteristics 652 (e.g., course or speed) and the updated course and speed ranges 673, 675.

The balloon system 120 is positioned at the target altitude with one or more of the ballast system 104 or the propulsion system, and the favorable airstream vector imparts one or more of course or speed guidance to the balloon system that decreases the differences between the balloon course or speed and the associated course or speed ranges 673, 675. Optionally, the onboard balloon control system 402 initiates operation of the propulsion system 108 to supplement course or speed otherwise provided with the favorable airstream. The control of the balloon system 120 with the onboard balloon control system 402 and the parameter ranges provided by the navigation parameter system 400 guides the balloon system 120 in this example to an updated target course 674 and updated target speed 676.

As previously discussed, one or more of the onboard balloon control system 402 continues to refine guidance of the balloon system 120 to within the associated parameter ranges including subranges, for instance to achieve a specified time of arrival at a forthcoming location (e.g., with respect to the speed range) or to achieve a specified refined position proximate to the forthcoming location (e.g., with respect to the course range). In still another example, the parameter ranges generated by the navigation parameter system 400 are updated or re-generated to refine control with the onboard balloon control system 402 or account for updated airstream vector information (e.g., variations in direction or magnitude of the vectors).

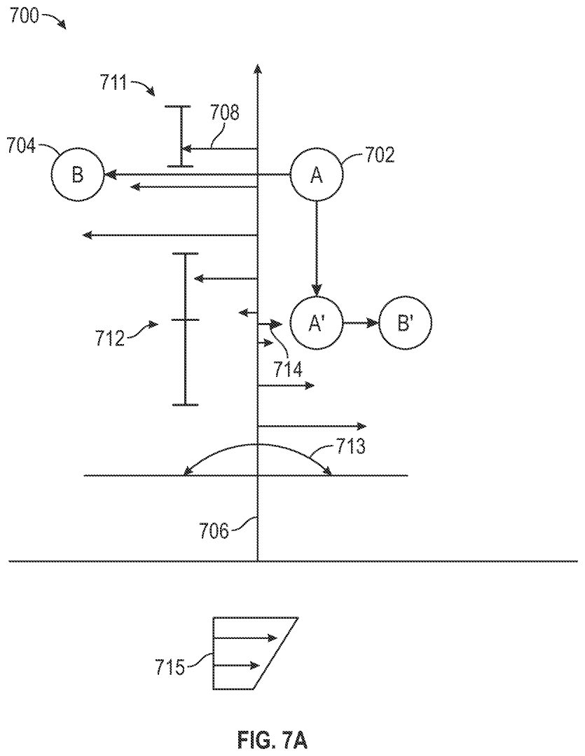

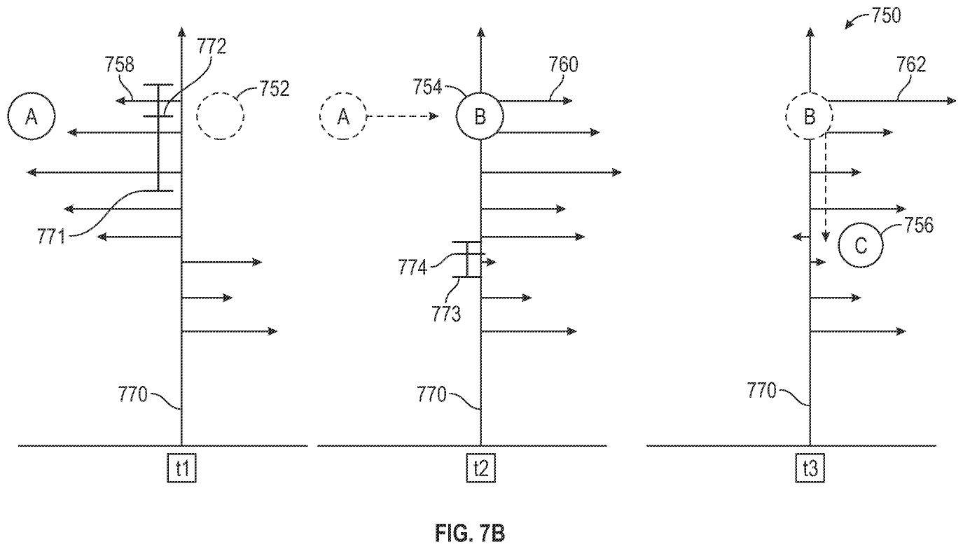

FIGS. 7A, 7B illustrate additional examples of parameter range control 700, 750 in a station seeking (or station seeking) context, The examples are illustrated in two dimensions for ease of explanation. The balloon system is shown an initial position 702 relative to a target balloon position 706. In this example, the target balloon position 706 is an example a “station” or stationary position in the context of the multiple position examples shown in FIGS. 3B and 6 having a balloon system that travels between positions.

In many aspects the parameter range control 700 shown in FIG. 7A (and 750 in FIG. 7B) are implemented similarly to the examples in FIGS. 3B and 6. For instance, one or more parameter ranges are generated by the navigation parameter system 400 (FIGS. 4 and 5). The onboard balloon control system 402. receives the one or more parameter ranges and then controls one or both of the ballast system 104 or the propulsion system 108 to decrease differences between present balloon kinematic characteristics (e.g., course, speed or the like) and associated parameter ranges, such as a course range or speed range.

As shown in FIG. 7A the altitude range 711 includes a range of altitudes leaving one or more air stream vectors 708 that decrease one or more of the course difference or speed difference relative to their respective ranges. In this example, the altitude range 711 is a discontinuous range because airstream vectors outside of the altitude range 711 (e.g., between upper and lower portions of the range) have relatively large magnitudes. As shown with the example off station position 704 the balloon at those altitudes outside of the range 711 is guided by the associated airstream vector to position B and thereby positioned away from the target balloon position 706.

In contrast, the target altitude 712 is selected from the altitude range 711 because it includes at least one air stream vector 708 that decreases one or both of course difference or speed difference relative to their respective ranges (e.g., the course range 713 and the speed range 715). In this example, the target altitude decreases the difference between the balloon system speed (a large magnitude airstream vector at A having an example airspeed of 80 miles per hour) and the speed range 715 (e.g., a range of 0 to 5 mph) by moving the balloon system to the target altitude 712 (show as A′) having a smaller magnitude airstream vector 708 (e.g., 10 mph). The smaller magnitude airstream vector 708 and associated speed of the balloon system in the airstream vector 708 at the target altitude 712 better comports with the speed range 715 (decreases the speed difference). Optionally, the onboard balloon control system 402 supplements the balloon system with propulsion in a converse direction to the airstream vector 708 at the target altitude 712 to further decrease the speed difference of the balloon system relative to the speed range 715.

In a similar manner, the target altitude 712 is selected from the altitude range 711 because it includes at least one airstream vector 708 that decreases the course difference of the balloon system (e.g., its present course) relative to the course range 713. The course range includes a range of courses for the balloon system that are based on available air stream vectors, balloon kinematics and locations of interest (e.g., the station seeking location or target balloon position 706). In this example, the course range includes approximately 180 degrees and is commensurate with the air stream vectors 708 directed to the right and left in FIG. 7A that facilitate station seeking. The onboard balloon control system 402 selects the target altitude 712 in part because the altitude 712 includes air stream vectors 708 that will decrease the difference between the present balloon course (e.g., at A, the initial position 702) and the course range 713. Optionally, the onboard balloon control system 402 supplements the decrease to the course difference provided by the airstream vector 708 at the target altitude 712 with propulsion assistance from the propulsion system 108 to further decrease the course difference between the balloon system kinematic characteristic (e.g., course) and the course range 713.

FIG. 7B is another example of parameter range control 750. In this example, the parameter range control 750 includes airstream vectors 758 and predicted (e.g., modeled or forecast) airstream vectors 760 and 762 for the generation of parameter ranges and control of the balloon system to conduct one or more of station seeking or guidance of the balloon system to a target balloon position (See FIGS. 3B and 6). As discussed herein, airstream vectors 758 and predicted airstream vectors 760, 762 permit control of the balloon system based on contemporary and future weather conditions. In the context of FIG. 7B, present and predicted airstream vectors 758, 760, 762 facilitate station seeking of the balloon system, for instance at the target balloon position 770.

At t1 (time 1) the balloon system is shown at the initial position 752 relative to the target balloon position 770. Airstream vectors 758 are illustrated with a variety of different vectors having different magnitudes and directions. Predicted airstream vectors 760 proximate to the target balloon position 770 are show at t2 (later time 2 relative to time 1). The predicted airstream vectors 760 vary relative to the airstream vectors 758 at t1 by way of direction, magnitude or both. In a similar manner, the predicted airstream vectors 762 at t3 vary relative to the vectors 758, 760 by way of direction, magnitude or both. The predicted airstream vectors 760, 762 are provided by a weather service (e.g., National Weather Service), model, forecast or the like.

The navigation parameter system 400 (see FIGS. 4 and 5) generates one or more parameter ranges. In the example shown in FIG. 7B altitude ranges 771, 773 are shown and generated based on the present balloon kinematic characteristics (e.g., course, speed, position or the like), the specified location (in this example target balloon position 770), and available airstream vectors. In other examples, the course and speed ranges discussed herein are generated for the parameter range control 70 example shown in FIG. 7B.

In a first example, the altitude range 771 is generated according to the balloon system kinematics (at the initial position 752), specified target position 770 (proximate to the initial position 752), the air stream vectors 758 and at least the predicted airstream vectors 760 for t2. In this example, one or both of the systems 400, 402 include the predicted air stream vectors 760 (and optionally 762) to determine the altitude range 771. Because the target balloon position 770 is stationary the systems includes component altitudes in the altitude range 771 that have relatively large magnitude airstream vectors 758, 760 for station seeking because the airstream vectors at t1 and t2 counteract each other and thereby maintain the balloon position proximate to the target balloon position 770 (as shown with A and B in the t2 diagram. The altitude range 771 is generated with the navigation parameter system 400 and provided to the onboard balloon control system 402.

In this example, the onboard balloon control system 402 selects the target altitude 772. The target altitude 772 includes at least one airstream vector that decreases one or both of course difference or speed difference relative to their associated course and speed ranges. In this example, the target altitude 772 for t1 having the predicted airstream vector 760 at future t2 decreases the speed difference between the present balloon kinematic speed at t1 and decreases the course difference between the present balloon kinematic course at t1. As shown graphically at t2 the predicted airstream vector 760 has an opposed direction to the vector 758 and a similar magnitude. Accordingly, the balloon system is guided to position B proximate to the target balloon position 770.

At t2 an updated altitude range 773 is generated by the navigation parameter system 400. The updated altitude range 773 is based on the balloon system kinematics (at t2), the specified target position 770, and airstream vectors 760, 762. In this example, one or both of the systems 400, 402 include predicted airstream vectors 762 to determine the altitude range. Because the target balloon position 770 is stationary the systems include altitudes in the altitude range 773 that have counteracting air stream vectors at t2 and t3 that maintain the balloon system proximate to position 770.

The onboard balloon control system 402 selects the target altitude 774 in a similar manner to the target altitude 772. The target altitude 774 includes at least one airstream vector that decreases one or both of course difference or speed difference relative to their associated course and speed ranges at time t3. In FIG. 7B the target altitude 774 (for t2) corresponds to the predicted airstream vector 762 at t3. The predicted airstream vector 762 decreases the speed difference between the (then) present balloon kinematic speed at t2 and decreases the course difference between the (then) present balloon kinematic course at t2. As shown graphically at t3 the predicted airstream vector 762 (corresponding to the target altitude 774) has a small magnitude and a vector directed to the left. Accordingly, the balloon system is guided from the previous target altitude 772 to the updated target altitude 774 to position C proximate to the target balloon position 770, and the predicted airstream vector 762 at the target altitude 774 guides the balloon system to the left toward the target balloon position at a relative low speed (corresponding to the short airstream vector).

### Various Notes and Aspects

Aspect 1 can include subject matter such as a control system for an atmospheric balloon system comprising: a navigation parameter system configured to generate parameter ranges for balloon operation, the navigation parameter system includes: a meteorological characteristic input including airstream vectors with associated coordinates; a balloon kinematic monitor configured to monitor balloon kinematics; an objective input including one or more of a target balloon position or the target balloon position and one or more intervening waypoints; and a parameter range generator configured to generate an altitude search range, a speed range, and a course range for the atmospheric balloon system based on the air stream vectors, the balloon kinematics, and one or more of the target balloon position or the target balloon position with one or more intervening waypoints; and an onboard balloon control system associated with the atmospheric balloon system, wherein the onboard balloon control system is in communication with the navigation parameter system, the onboard balloon control system includes: a comparator configured to determine a course difference of a balloon course of the atmospheric balloon system relative to the course range and a speed difference of a balloon speed of the atmospheric balloon system relative to the speed range; an altitude selection module configured to select a target altitude within the altitude search range having an air stream that decreases one or more of the course difference or the speed difference; a propulsion selection module configured to select propulsion values that decrease one or more of the course difference or the speed difference; and a balloon control interface configured to control one or more of a balloon altitude or balloon propulsion based on one or more of the target altitude, course difference or speed difference.

Aspect 2 can include, or can optionally be combined with the subject matter of Aspect 1, to optionally include wherein the atmospheric balloon system includes a position sensor, and the onboard balloon control system is configured to communicate the balloon position to the balloon kinematic monitor.

Aspect 3 can include, or can optionally be combined with subject matter of one or any combination of Aspects 1 or 2 to optionally include wherein the navigation parameter system is remote relative to the atmospheric balloon system.

Aspect 4 can include, or can optionally be combined with the subject matter of one or any combination of Aspects 1-3 to optionally include the atmospheric balloon system, and the onboard balloon control system is included with the atmospheric balloon system.

Aspect 5 can include, or can optionally be combined with the subject matter of one or any combination of Aspects 1-4 to optionally include wherein the atmospheric balloon system includes an elevation control system and a propulsion system.

Aspect 6 can include, or can optionally be combined with the subject matter of Aspects 1-5 to optionally include wherein the altitude selection module is assigned a first control priority and the propulsion selection module is assigned a second control priority.

Aspect 7 can include, or can optionally be combined with the subject matter of Aspects 1--6 to optionally include wherein the propulsion selection module is configured to select one or more of a target course or a target speed that decreases one or more of the course difference or the speed difference at the selected target altitude.

Aspect 8 can include or can optionally be combined with the subject matter of Aspects 1-7 to optionally include wherein the altitude selection module selects a combination of propulsion and elevation control maneuvers to minimize energy consumption of the elevation control system and propulsion system while the propulsion selection module decreases one or more of the course difference or the speed difference.

Aspect 9 can include, or can optionally be combined with the subject matter of Aspects 1-8 to optionally include wherein the propulsion selection module is configured to decrease one or more of the course difference or the speed difference based on the selected target altitude and air stream vectors at the selected target altitude.

Aspect 10 can include, or can optionally be combined with the subject matter of Aspects 1-9 to optionally include wherein the balloon kinematic monitor is configured to monitor the balloon position and time; and the objective input includes one or more indexed times associated with the target balloon position or one or more intervening waypoints, wherein the one or more indexed times associated with the target balloon position or one or more intervening waypoints include one or more times of arrival.

Aspect 11 can include, or can optionally be combined with the subject matter of Aspects 1-10 to optionally include wherein the altitude selection module is configured to select the target altitude within the altitude search range for the atmospheric balloon system at the balloon position, the target balloon position or one or more intervening waypoints at the one or more indexed times, the target altitudes each having associated air streams at the indexed times that decrease one or more of the course difference, the speed difference, or energy consumption of the atmospheric balloon system.

Aspect 12 can include, or can optionally be combined with the subject matter of Aspects 1-11 to optionally include wherein the balloon kinematic monitor is configured to monitor one or more of balloon position, course or speed.

Aspect 13 can include, or can optionally be combined with the subject matter of Aspects 1-12 to optionally include wherein one or more of the course range or the speed range includes a plurality of course values and speed values, respectively; and the propulsion selection module is configured to select propulsion values that decrease one or more of the course difference or the speed difference relative to one or more of the course values or speed values within the respective course range or speed range.

Aspect 14 can include, or can optionally be combined with the subject matter of Aspects 1-13 to optionally include a control system for an atmospheric balloon system comprising: a navigation parameter system configured to generate one or more parameter ranges for balloon operation, the navigation parameter system includes: a meteorological characteristic input including airstream vectors with associated coordinates; a balloon kinematic monitor configured to monitor balloon kinematics; an objective input including one or more of a target balloon position or the target balloon position and one or more intervening waypoints; and a parameter range generator configured to generate an altitude search range for the atmospheric balloon system based on the air stream vectors, balloon kinematics, and one or more of the target balloon position or the target balloon position with one or more intervening waypoints; and an onboard balloon control system associated with the atmospheric balloon system, wherein the onboard balloon control system is in communication with the navigation parameter system, the onboard balloon control system includes: a comparator configured to determine a course difference of a measured course of the atmospheric balloon system relative to a specified course to the target balloon position or intervening waypoints; an altitude selection module configured to select a target altitude within the altitude search range having an air stream vector that decreases the course difference; a propulsion selection module configured to select a propulsion value that decreases the course difference; and a balloon control interface configured to control one or more of balloon altitude or balloon propulsion based on one or more of the target altitude or course difference.

Aspect 15 can include, or can optionally be combined with the subject matter of Aspects 1-14 to optionally include wherein the comparator is configured to determine a speed difference of a measured speed of the atmospheric balloon system relative to a specified speed; the altitude selection module is configured to select the target altitude within the altitude search range having the air stream vector that decreases the speed difference; the propulsion selection module is configured to select the propulsion value that decreases the speed difference within the altitude search range; and the balloon control interface is configured to control balloon propulsion based on one or more of the target altitude, course difference or the speed difference.

Aspect 16 can include, or can optionally be combined with the subject matter of Aspects 1-15 to optionally include wherein the atmospheric balloon system includes a position sensor, and the onboard balloon control system configured to communicate the balloon position to the balloon kinematic monitor.

Aspect 17 can include, or can optionally be combined with the subject matter of Aspects 1-16 to optionally include wherein the navigation parameter system is remote relative to the atmospheric balloon system.

Aspect 18 can include, or can optionally be combined with the subject matter of Aspects 1-17 to optionally include the atmospheric balloon system, and the onboard balloon control system is included with the atmospheric balloon system.

Aspect 19 can include, or can optionally be combined with the subject matter of Aspects 1-18 to optionally include wherein the atmospheric balloon system includes an elevation control system and a propulsion system.

Aspect 20 can include, or can optionally be combined with the subject matter of Aspects 1-19 to optionally include wherein the navigation parameter system includes an airstream indexing module configured to index airstream vectors with coordinates and times.

Aspect 21 can include, or can optionally be combined with the subject matter of Aspects 1-20 to optionally include wherein the balloon kinematic monitor is configured to monitor the balloon position and time; and the objective input includes one or more indexed times associated with the target balloon position or one or more intervening waypoints, wherein the one or more indexed times associated with the target balloon position or one or more intervening waypoints include one or more times of arrival.

Aspect 22 can include, or can optionally be combined with the subject matter of Aspects 1-21 to optionally include wherein the altitude selection module is configured to select target altitudes within the altitude search range for the atmospheric balloon system at the balloon position, the target balloon position or one or more intervening waypoints at the one or more indexed times, the target altitudes each having associated indexed air streams at the indexed times that decrease the course difference.

Aspect 23 can include, or can optionally be combined with the subject matter of Aspects 1-22 to optionally include wherein the balloon kinematic monitor is configured to monitor one or more of balloon position, course or speed.

Aspect 24 can include, or can optionally be combined with the subject matter of Aspects 1-23 to optionally include wherein the specified course includes a course range, and the specified speed includes a speed range.

Aspect 25 can include, or can optionally be combined with the subject matter of Aspects 1-24 to optionally include a method for controlling an atmospheric balloon system comprising: generating one or more parameter ranges for balloon operation with a navigation parameter system including: monitoring balloon kinematics of the atmospheric balloon system; receiving an objective input including one or more of a target balloon position or the target balloon position and one or more intervening waypoints; receiving a meteorological characteristic input including airstream vectors with associated coordinates; and generating an altitude search range for the atmospheric balloon system based on the air stream vectors, balloon kinematics, and one or more of the target balloon position or the target balloon position with the one or more intervening waypoints; and determining control instructions for the atmospheric balloon system with an onboard balloon control system in communication with the navigation parameter system, determining control instructions includes: selecting a target altitude within the altitude search range, the target altitude having an air stream vector that decreases a course difference of the atmospheric balloon system relative to a specified course; and selecting a propulsion value that decreases the course difference.

Aspect 26 can include, or can optionally be combined with the subject matter of Aspects 1-25 to optionally include wherein selecting the target altitude within the altitude search range includes selecting the target altitude having an air stream vector that decreases a speed difference of the atmospheric balloon system relative to a specified speed; and comprising: selecting the propulsion value that decreases the speed difference.

Aspect 27 can include, or can optionally be combined with the subject matter of Aspects 1-26 to optionally include wherein selecting the propulsion value is conducted to guide the atmospheric balloon system into the air stream vector.

Aspect 28 can include, or can optionally be combined with the subject matter of Aspects 1-27 to optionally include wherein selecting the propulsion value is conducted to control the atmospheric balloon system while in the air stream vector.

Aspect 29 can include, or can optionally be combined with the subject matter of Aspects 1-28 to optionally include controlling a balloon course and a balloon speed based on the selected propulsion value that decreases one or more of the course and speed differences.

Aspect 30 can include, or can optionally be combined with the subject matter of Aspects 1-29 to optionally include wherein monitoring balloon kinematics includes monitoring one or more of a balloon course or a balloon speed of the atmospheric balloon system.

Aspect 31 can include, or can optionally be combined with the subject matter of Aspects 1-30 to optionally include wherein generating the altitude search range with the navigation parameter system includes remotely generating the altitude search range with the navigation parameter system remote from the atmospheric balloon system.

Aspect 32 can include, or can optionally be combined with the subject matter of Aspects 1-31 to optionally include wherein selecting the target altitude within the altitude search range is before selecting the propulsion value that decreases the course difference.

Aspect 33 can include, or can optionally be combined with the subject matter of Aspects 1-32 to optionally include wherein selecting the propulsion value that decreases the course difference is based on the selected target altitude having the air stream vector.

Aspect 34 can include, or can optionally be combined with the subject matter of Aspects 1-33 to optionally include controlling a balloon altitude of the atmospheric balloon system based on the monitored balloon kinematics including balloon position relative to the target altitude.

Aspect 35 can include, or can optionally be combined with the subject matter of Aspects 1-34 to optionally include wherein determining control instructions for the atmospheric balloon system with an onboard balloon control system includes: conducting a survey maneuver within the altitude search range to index air stream vectors that decrease the course difference relative to the specified course; and wherein selecting the target altitude within the altitude search range includes selecting the target altitude from the indexed air stream vectors.

Aspect 36 can include, or can optionally be combined with the subject matter of Aspects 1-35 to optionally include wherein the air stream vector includes first and second air stream vectors, and selecting a target altitude within the altitude search range includes: selecting a first target altitude within the altitude search range at a first waypoint at a first time, the first target altitude having a first air stream vector proximate to the first waypoint at the first time that, decreases the course difference relative to the specified course; and selecting a second target altitude within the altitude search range at a second waypoint different than the first waypoint, the second target altitude having a second air stream vector proximate to the second waypoint at the second time that decreases the course difference relative to the specified course.

Aspect 37 can include, or can optionally be combined with the subject matter of Aspects 1-36 to optionally include wherein selecting the propulsion value that decreases the course difference includes: selecting a first propulsion value that decreases the course difference relative to the specified course at the first waypoint at the first time; and selecting a second propulsion value that decreases the course difference relative to the specified course at the second waypoint at the second time.

Aspect 38 can include, or can optionally be combined with the subject matter of Aspects 1-37 to optionally include wherein the first waypoint includes one or more of a current balloon position or future balloon position, or the second waypoint includes another future balloon position or a target balloon position.

Aspect 39 can include, or can optionally be combined with the subject matter of Aspects 1-38 to optionally include wherein generating the altitude search range is repeated for each of the first and second waypoints based on the air stream vectors proximate the first and second waypoints.

Aspect 40 can include, or can optionally be combined with the subject matter of Aspects 1-39 to optionally include wherein monitoring the balloon kinematics of the atmospheric balloon system includes monitoring one or more of balloon position, balloon course or balloon speed.

Aspect 41 can include, or can optionally be combined with the subject matter of Aspects 1-40 to optionally include wherein the specified course includes a course range and a speed range; and comprising: generating the course range and the speed range for the atmospheric balloon system based on the air stream vectors, balloon kinematics, and one or more of the target balloon position or the target balloon position with the one or more intervening waypoints; and selecting the propulsion value includes selecting the propulsion value that decreases the course difference of the atmospheric balloon system relative to the course range.

Aspect 42 can include, or can optionally be combined with the subject matter of Aspects 1-41 to optionally include wherein selecting the propulsion value includes selecting the propulsion value that decreases a speed difference of the atmospheric balloon system relative to the speed range.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times, Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects or examples (or one or more aspects thereof) may be used in combination with each other. Other embodiments can he used, such as by one of ordinary skill in the art upon reviewing the above description. The Abstract is provided to comply with 37 C.F.R. § 1.72(b), to allow the reader to quickly ascertain the nature of the technical disclosure, It is submitted with the understanding that it will not he used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A control system for an atmospheric balloon system comprising:
a navigation parameter system configured to generate parameter ranges for balloon operation, the navigation parameter system includes:
a meteorological characteristic input including airstream vectors with associated coordinates;
a balloon kinematic monitor configured to monitor balloon kinematics;
an objective input including one or more of a target balloon position or the target balloon position and one or more intervening waypoints; and
a parameter range generator configured to generate an altitude search range, a speed range, and a course range for the atmospheric balloon system based on the air stream vectors, the balloon kinematics, and one or more of the target balloon position or the target balloon position with one or more intervening waypoints; and
an onboard balloon control system associated with the atmospheric balloon system, wherein the onboard balloon control system is in communication with the navigation parameter system, the onboard balloon control system includes:
a comparator configured to determine a course difference of a balloon course of the atmospheric balloon system relative to the course range and a speed difference of a balloon speed of the atmospheric balloon system relative to the speed range;
an altitude selection module configured to select a target altitude within the altitude search range having an air stream that decreases one or more of the course difference or the speed difference;
a propulsion selection module configured to select propulsion values that decrease one or more of the course difference or the speed difference; and
a balloon control interface configured to control e or more of a balloon altitude or balloon propulsion based on one or more of the target altitude, course difference or speed difference.

2. The control system of claim 1, wherein the atmospheric balloon system includes a position sensor, and the onboard balloon control system is configured to communicate the balloon position to the balloon kinematic monitor.

3. The control system of claim 1, wherein the navigation parameter system is remote relative to the atmospheric balloon system.

4. The control system of claim 1 comprising the atmospheric balloon system, and the onboard balloon control system is included with the atmospheric balloon system.

5. The control system of claim 4, wherein the atmospheric balloon system includes an elevation control system and a propulsion system.

6. The control system of claim 5, wherein the altitude selection module is assigned a first control priority and the propulsion selection module is assigned a second control priority.

7. The control system of claim 6, wherein the propulsion selection module is configured to select one or more of a target course or a target speed that decreases one or more of the course difference or the speed difference at the selected target altitude.

8. The control system of claim 5 wherein the altitude selection module selects a combination of propulsion and elevation control maneuvers to minimize energy consumption of the elevation control system and propulsion system while the propulsion selection module decreases one or more of the course difference or the speed difference.

9. The control system of claim 1, wherein the propulsion selection module is configured to decrease one or more of the course difference or the speed difference based on the selected target altitude and air stream vectors at the selected target altitude.

10. The control system of claim 1, wherein the balloon kinematic monitor is configured to monitor the balloon position and time; and
the objective input includes one or more indexed times associated with the target balloon position or one or more intervening waypoints, wherein the one or more indexed times associated with the target balloon position or one or more intervening waypoints include one or more times of arrival.

11. The control system of claim 10, wherein the altitude selection module is configured to select the target altitude within the altitude search range for the atmospheric balloon system at the balloon position, the target balloon position or one or more intervening waypoints at the one or more indexed times, the target altitudes each having associated air streams at the indexed times that decrease one or more of the course difference, the speed difference, or energy consumption of the atmospheric balloon system.

12. The control system of claim 1, wherein the balloon kinematic monitor is configured to monitor one or more of balloon position, course or speed.

13. The control system of claim 1, wherein one or more of the course range or the speed range includes a plurality of course values and speed values, respectively; and
the propulsion selection module is configured to select propulsion values that decrease one or more of the course difference or the speed difference relative to one or more of the course values or speed values within the respective course range or speed range.

14. A control system for an atmospheric balloon system comprising:
a navigation parameter system configured to generate one or more parameter ranges for balloon operation, the navigation parameter system includes:
a meteorological characteristic input including airstream vectors with associated coordinates;
a balloon kinematic monitor configured to monitor balloon kinematics;
an objective input including one or more of a target balloon position or the target balloon position and one or more intervening waypoints; and
a parameter range generator configured to generate an altitude search range for the atmospheric balloon system based on the air stream vectors, balloon kinematics, and one or more of the target balloon position or the target balloon position with one or more intervening waypoints; and
an onboard balloon control system associated with the atmospheric balloon system, wherein the onboard balloon control system is in communication with the navigation parameter system, the onboard balloon control system includes:
a comparator configured to determine a course difference of a measured course of the atmospheric balloon system relative to a specified course to the target balloon position or intervening waypoints;
an altitude selection module configured to select a target altitude within the altitude search range having an air stream vector that decreases the course difference;
a propulsion selection module configured to select a propulsion value that decreases the course difference; and
a balloon control interface configured to control one or more of balloon altitude or balloon propulsion based on one or more of the target altitude or course difference.

15. The control system of claim 14, wherein the comparator is configured to determine a speed difference of a measured speed of the atmospheric balloon system relative to a specified speed;
the altitude selection module is configured to select the target altitude within the altitude search range having the air stream vector that decreases the speed difference;
the propulsion selection module is configured to select the propulsion value that decreases the speed difference within the altitude search range; and
the balloon control interface is configured to control balloon propulsion based on one or more of the target altitude, course difference or the speed difference.

16. The control system of claim 14 wherein the atmospheric balloon system includes a position sensor, and the onboard balloon control system is configured to communicate the balloon position to the balloon kinematic monitor.

17. The control system of claim 14, wherein the navigation parameter systems is remote relative to the atmospheric balloon system.

18. The control system of claim 14 comprising the atmospheric balloon system, and the onboard balloon control system is included with the atmospheric balloon system.

19. The control system of claim 14, wherein the atmospheric balloon system includes an elevation control system and a propulsion system.

20. The control system of claim 14, wherein the navigation parameter system includes an airstream indexing module configured to index airstream vectors with coordinates and times.

21. The control system of claim 14, wherein the balloon kinematic monitor is configured to monitor the balloon position and time; and
the objective input includes one or more indexed times associated with the target balloon position or one or more intervening waypoints, wherein the one or more indexed times associated with the target balloon position or one Or more intervening waypoints include one or more times of arrival.

22. The control system of claim 21, wherein the altitude selection module is configured to select target altitudes within the altitude search range for the atmospheric balloon system at the balloon position, the target balloon position or one or more intervening waypoints at the one or more indexed times, the target altitudes each having associated indexed air streams at the indexed times that decrease the course difference.

23. The control system of claim 14, wherein the balloon kinematic monitor is configured to monitor one or more of balloon position, course or speed.

24. The control system of claim 14, wherein the specified course includes a course range, and the specified speed includes a speed range.

25. A method for controlling an atmospheric balloon system comprising:
generating one or more parameter ranges for balloon operation with a navigation parameter system including:
monitoring balloon kinematics of the atmospheric balloon system;
receiving an objective input including one or more of a target balloon position or the target balloon position and one or more intervening waypoints;
receiving a meteorological characteristic input including airstream vectors with associated coordinates; and
generating an altitude search range for the atmospheric balloon system based on the air stream vectors, balloon kinematics, and one or more of the target balloon position or the target balloon position with the one or more intervening waypoints; and
determining control instructions for the atmospheric balloon system with an onboard balloon control system in communication with the navigation parameter system, determining control instructions includes:
selecting a target altitude within the altitude search range, the target altitude having an air stream vector that decreases a course difference of the atmospheric balloon system relative to a specified course; and
selecting a propulsion value that decreases the course difference.

26. The method of claim 25, wherein selecting the target altitude within the altitude search range includes selecting the target altitude having an air stream vector that decreases a speed difference of the atmospheric balloon system relative to a specified speed; and comprising:
selecting the propulsion value that decreases the speed difference.

27. The method of claim 26, wherein selecting the propulsion value is conducted to guide the atmospheric balloon system into the air stream vector.

28. The method of claim 27, wherein selecting the propulsion value is conducted to control the atmospheric balloon system while in the air stream vector.

29. The method of claim 26 comprising controlling a balloon course and a balloon speed based on the selected propulsion value that decreases one or more of the course and speed differences.

30. The method of claim 25, wherein monitoring balloon kinematics includes monitoring one or more of a balloon course or a balloon speed of the atmospheric balloon system.

31. The method of claim 25, wherein generating the altitude search range with the navigation parameter system includes remotely generating the altitude search range with the navigation parameter system remote from the atmospheric balloon system.

32. The method of claim 25, wherein selecting the target altitude within the altitude search range is before selecting the propulsion value that decreases the course difference.

33. The method of claim 25, wherein selecting the propulsion value that decreases the course difference is based on the selected target altitude having the air stream vector.

34. The method of claim 25 comprising controlling a balloon altitude of the atmospheric balloon system based on the monitored balloon kinematics including balloon position relative to the target altitude.

35. The method of claim 25, wherein determining control instructions for the atmospheric balloon system with an onboard balloon control system includes:
conducting a survey maneuver within the altitude search range to index air stream vectors that decrease the course difference relative to the specified course; and
wherein selecting the target altitude within the altitude search range includes selecting the target altitude from the indexed air stream vectors.

36. The method of claim 25. wherein the air stream vector includes first and second air stream vectors, and selecting a target altitude within the altitude search range includes:
selecting a first target altitude within the altitude search range at a first waypoint at a first time, the first target altitude having a first air stream vector proximate to the first waypoint at the first time that decreases the course difference relative to the specified course; and
selecting a second target altitude within the altitude search range at a second waypoint different than the first waypoint, the second target altitude having a second air stream vector proximate to the second waypoint at the second time that decreases the course difference relative to the specified course.

37. The method of claim 36, wherein selecting the propulsion value that decreases the course difference includes:
selecting a first propulsion value that decreases the course difference relative to the specified course at the first waypoint at the first time; and
selecting a second propulsion value that decreases the course difference relative to the specified course at the second waypoint at the second time.

38. The method of claim 36, wherein the first waypoint includes one or more of a current balloon position or future balloon position, or the second waypoint includes another future balloon position or a target balloon position.

39. The method of claim 36, w herein generating the altitude search range is repeated for each of the first and second waypoints based on the air stream vectors proximate the first and second waypoints.

40. The method of claim 25, wherein monitoring the balloon kinematics of the atmospheric balloon system includes monitoring one or more of balloon position, balloon course or balloon speed.

41. The method of claim 25, wherein the specified course includes a co range and a speed range; and comprising:
generating the course range and the speed range for the atmospheric balloon system based on the air stream vectors, balloon kinematics, and one or more of the target balloon position or the target balloon position with the one or more intervening waypoints; and
selecting the propulsion value includes selecting the propulsion value that decreases the course difference of the atmospheric balloon system relative to the course range.

42. The method of claim 41, wherein selecting the propulsion value includes selecting the propulsion value that decreases a speed difference of the atmospheric balloon system relative to the speed range.
